(19) United States
(12) Patent Application Publication
(10) Pub. No.: US 2024/0242575 A1
(43) Pub. Date: Jul. 18, 2024

(54) DLT-BASED LOTTERY GAMING SYSTEM AND METHOD

(71) Applicants: Richard Radomir Hamilton, Inverness, FL (US); Roy Kenneth Edwards, JR., Dunnellon, FL (US)

(72) Inventors: Richard Radomir Hamilton, Inverness, FL (US); Roy Kenneth Edwards, JR., Dunnellon, FL (US)

(21) Appl. No.: 18/470,719

(22) Filed: Sep. 20, 2023

Related U.S. Application Data
(60) Provisional application No. 63/413,545, filed on Oct. 5, 2022.

(51) Int. Cl. G07F 17/32; G06F 7/58; G06Q 20/02; G06Q 20/06; G06Q 20/36

(52) U.S. Cl. CPC G07F 17/329; G06F 7/588; G06Q 20/02; G06Q 20/065; G06Q 20/3678; G07F 17/323; G07F 17/3241; G06Q 2220/00

(57) ABSTRACT

A distributed ledger technology (DLT)-based lottery gaming system and method for executing lottery games. Players are able to participate in a multi-round lottery game that is executed using an associated smart contract and the lottery game includes a plurality of winning numbers (e.g., six (6) total). Under control of the smart contract, the players make an initial plurality of lottery ticket requests such that each initial lottery ticket request associated with a player of has an initial defined requested total lottery ticket count associated with the player indicating the number of tickets they wish to purchase and to be issued to them. A record of the lottery tickets issued and to which players are recorded on the DLT ledger. The lottery game is executed starting with an initial round and allowing for multiple subsequent rounds to be executed until a winner is identified.

### CROSS-REFERENCE TO RELATED APPLICATION

This application claims the benefit of U.S. Provisional Patent Application 63/413,545, filed Oct. 5, 2022, which is hereby incorporated by reference herein in its entirety.

### FIELD OF THE INVENTION

The present invention relates generally to gaming, and more particularly, to a digital ledger technology (DLT)-based lottery gaming system and method.

### BACKGROUND OF THE INVENTION

Many different types of lottery games have been sold over the course of history in various jurisdictions. The “traditional” game has a very long history and is based on the concept of a raffle. lottery games and instant games, whether run by governmental or private entities, have proven to be quite popular, and are an important revenue source for the lottery game sponsors. Participation in a game gives a person a chance to win a cash or a merchandise prize while also allowing private parties and lottery authorities to collect movies for public or charitable purposes. When taxed, the sales from games also provide additional revenue to state and city governments. Generally, tickets are sold with unique numbers. The drawing mechanism is developed, often using balls, sometimes hundreds of them, each with a unique number corresponding to a ticket. Players may sometime select their own numbers for their ticket and other times individual digits for winning numbers are drawn randomly from one or more machines. The drawings are held so that a large prize and subordinate prizes are paid according to the unique numbers drawn and delegated to a particular prize level. Sometimes subordinate prizes are paid for matching part but not all of the numbers as long as the digits being matched are a subset of the digits on the balls drawn in exact order.

For example, one typical lotto game in the United States and internationally involves establishing a field of numbers from one to Z. A player chooses, say, six of these numbers. The lottery then draws six numbers, and a top prize is won if all numbers match in any order. The odds of winning the top prize can be altered by making Z a larger number. In doing so there will be fewer winners of the top prize, which allows lottery sellers to offer a large jackpot prize. The prize can further be enhanced if no winner is chosen in a particular drawing. The lottery is then able to bank part or all of the non-won prize money from a previous drawing and offer it as an incentive for sales in a subsequent drawing, by increasing the size of the jackpot. Draw-type lottery games are well-known wherein players select (or are randomly assigned) a set of player indicia from a field of indicia. For example, Powerball is an American lottery game offered by 45 states, the District of Columbia, Puerto Rico and the US Virgin Islands coordinated by the Multi-State Lottery Association (MUSL), a nonprofit organization, wherein players select five numbers from the field of numbers 1 through 59 (“5/59” draw), and 1 number (I.e., the Powerball) from a field of numbers 1 through 39 (“1/39” draw). At a subsequent drawing conducted by the lottery authority, five numbers are randomly generated from the field of fifty-pine numbers, and one number is randomly generated from the field of thirty-nine numbers. A win is determined for the player by matching one of nine possible match combinations. Various “pick-3”, “pick-4”, and other types of draw games are also well-known.

With the typical draw-type games, a defined subset of indicia is randomly generated by the lottery from the field of indicia, and a win is determined by players simply comparing their selected player indicia to the randomly drawn lottery indicia, with the prize typically determined as a function of the number of matches. In certain games, the order of the matches may also be considered in the prize determination. A disadvantage of these conventional draw-type games is that the randomly generated set of lottery indicia has the same value to all players and is limited to use for one type of game. States or other jurisdictions often host a number of different types of draw games, with each such game requiring their own random draw event. This adds to the complexity and expense of the individual games. In addition, the conventional random draw events are limited in their versatility and ability to generate additional excitement and interest in the game. Given the existing demand for and growing interest in lottery games there exists a continual need for improved games that will generate increased player interest and lottery revenues.

Accordingly, there is a need for an improved lottery gaming system and method.

### SUMMARY OF THE INVENTION

The present invention is directed to a distributed ledger technology (DLT)-based lottery gaming system and method for implementing and executing lottery games.

In a first implementation of the invention, a DLT-based lottery gaming system is provided for implementing and executing lottery games. The system comprising at least:
a processor;
a memory storing instructions that when executed cause the processor to perform operations comprising:
executing a smart contract associated with a lottery game, the lottery game comprising a plurality of winning numbers;
under control of the smart contract executed:
receiving an initial plurality of lottery ticket requests, each initial lottery ticket request associated with a respective one player of an initial plurality of players and having an initial defined requested total lottery ticket count associated with the respective one player;
issuing and recording on a distributed technology ledger (DLT) an initial number of lottery tickets to each respective one player of the initial plurality of players in accordance with the initial defined requested total lottery ticket count associated therewith, each lottery ticket of the initial number of lottery tickets issued comprising a plurality of potential winning numbers;
executing an initial round of the lottery game;
determining whether any one of the respective one players of the initial plurality of players is a winner of the initial round of the lottery game executed based on a matching of a specified number of required winning number matches between the plurality of potential winning numbers of a particular one lottery ticket of the initial number of lottery tickets issued thereto with the plurality of winning numbers of the lottery game, and in accordance with the determination:
   if the winner of the lottery game is determined then:
      identifying the particular one lottery ticket of the initial number of lottery tickets issued to the respective one player determined as the winner of the lottery game based on the matching,
      notifying the respective one player determined as the winner of the lottery game of their lottery game win;
      transmitting a lottery prize associated with the lottery game to the respective one player determined as the winner; and
      recording results of the lottery game executed on the DLT ledger;
   otherwise, if the winner of the lottery game is not determined then:
      (a) updating the plurality of winning lottery numbers and redefining the specified number of required winning number matches;
      (b) receiving one or more subsequent lottery ticket requests, each of the one or more subsequent lottery ticket requests associated with a respective one player of a subsequent plurality of players and having a subsequent defined requested total lottery ticket count associated with the respective one player of the subsequent plurality of players, and wherein the subsequent plurality of players comprises all or any portion of the initial plurality of players and any new player joining for any subsequent round and the subsequent defined requested total lottery ticket count may be any number of lottery tickets;
      (c) issuing and recording on the DLT ledger a subsequent number of lottery tickets to each respective one player of the subsequent plurality of players making the one or more subsequent lottery ticket requests in accordance with the subsequent defined requested total lottery ticket count associated therewith, each lottery ticket of the subsequent number of lottery tickets issued comprising a plurality of potential winning numbers;
      (d) defining a current total number of lottery tickets issued for each respective one player of the subsequent plurality of players, the current total number of lottery tickets defined comprising a combination of the initial number of lottery tickets issued to the respective one player and any and all of the subsequent number of lottery tickets issue thereto;
      (e) executing a subsequent round of the lottery game;
      (f) determining whether any one of the respective one players of the subsequent plurality of players is a winner of the subsequent round of the lottery game executed based on a matching of the specified number of required winning number matches redefined between the plurality of potential winning numbers of a particular one lottery ticket of the current total number of lottery tickets defined with the plurality of winning numbers updated, and in accordance with the determination:
      (g) if the winner is identified then:
         identifying the particular one lottery ticket of the current total number of lottery tickets issued to the respective one player of the subsequent plurality of players determined as the winner of the lottery game;
         notifying the respective one player of the subsequent plurality of players determined as the winner of the lottery game of their lottery win;
         transmitting the lottery prize associated with the lottery game to the respective one player of the subsequent plurality of players determined as the winner; and
         recording results of the lottery game executed on the DLT ledger;
         otherwise, if the winner of the subsequent round of the lottery game executed is not determined then repeating steps (a) through (g) until the winner is determined.

In a second aspect, a method is provided for implementing and executing lottery games. The method comprising:
executing a smart contract associated with a lottery game, the lottery game comprising a plurality of winning numbers;
under control of the smart contract executed:
receiving an initial plurality of lottery ticket requests, each initial lottery ticket request associated with a respective one player of an initial plurality of players and having an initial defined requested total lottery ticket count associated with the respective one player;
issuing and recording on a distributed technology ledger (DLT) an initial number of lottery tickets to each respective one player of the initial plurality of players in accordance with the initial defined requested total lottery ticket count associated therewith, each lottery ticket of the initial number of lottery tickets issued comprising a plurality of potential winning numbers;
executing an initial round of the lottery game;
determining whether any one of the respective one players of the initial plurality of players is a winner of the initial round of the lottery game executed based on a matching of a specified number of required winning number matches between the plurality of potential winning numbers of a particular one lottery ticket of the initial number of lottery tickets issued thereto with the plurality of winning numbers of the lottery game, and in accordance with the determination:
   if the winner of the lottery game is determined then:
      identifying the particular one lottery ticket of the initial number of lottery tickets issued to the respective one player determined as the winner of the lottery game based on the matching;
      notifying the respective one player determined as the winner of the lottery game of their lottery game win;
      transmitting a lottery prize associated with the lottery game to the respective one player determined as the winner; and
      recording results of the lottery game executed on the DLT ledger;
   otherwise, if the winner of the lottery game is not determined then:
      (a) updating the plurality of winning lottery numbers and redefining the specified number of required winning number matches;
      (b) receiving one or more subsequent lottery ticket requests, each of the one or more subsequent lottery ticket requests associated with a respective one player of a subsequent plurality of players and having a subsequent defined requested total lottery ticket count associated with the respective one player of the subsequent plurality of players, and wherein the subsequent plurality of players comprises all or any portion of the initial plurality of players and any new player joining for any subsequent round and the subsequent defined requested total lottery ticket count may be any number of lottery tickets;
      (c) issuing and recording on the DLT ledger a subsequent number of lottery tickets to each respective one player of the subsequent plurality of players making the one or more subsequent lottery ticket requests in accordance with the subsequent defined requested total lottery ticket count associated therewith, each lottery ticket of the subsequent number of lottery tickets issued comprising a plurality of potential winning numbers;
      (d) defining a current total number of lottery tickets issued for each respective one player of the subsequent plurality of players, the current total number of lottery tickets defined comprising a combination of the initial number of lottery tickets issued to the respective one player and any and all of the subsequent number of lottery tickets issue thereto;
      (e) executing a subsequent round of the lottery game;
      (f) determining whether any one of the respective one players of the subsequent plurality of players is a winner of the subsequent round of the lottery game executed based on a matching of the specified number of required winning number matches redefined between the plurality of potential winning numbers of a particular one lottery ticket of the current total number of lottery tickets defined with the plurality of winning numbers updated, and in accordance with the determination:
      (g) if the winner is identified then:
         identifying the particular one lottery ticket of the current total number of lottery tickets issued to the respective one player of the subsequent plurality of players determined as the winner of the lottery game;
         notifying the respective one player of the subsequent plurality of players determined as the winner of the lottery game of their lottery win;
         transmitting the lottery prize associated with the lottery game to the respective one player of the subsequent plurality of players determined as the winner; and
         recording results of the lottery game executed on the DLT ledger;
         otherwise, if the winner of the subsequent round of the lottery game executed is not determined then repeating steps (a) through (g) until the winner is determined.

In a third aspect, a user device is provided and configured for interfacing with the DLT-based lottery gaming system and/or executing a lottery gaming application for implementing and executing lottery games. The user device comprising at least:
a processor;
a memory storing instructions that when executed cause the processor to perform operations comprising:
executing a smart contract associated with a lottery game, the lottery game comprising a plurality of winning numbers;
under control of the smart contract executed:
receiving an initial plurality of lottery ticket requests, each initial lottery ticket request associated with a respective one player of an initial plurality of players and having an initial defined requested total lottery ticket count associated with the respective one player;
issuing and recording on a distributed technology ledger (DLT) an initial number of lottery tickets to each respective one player of the initial plurality of players in accordance with the initial defined requested total lottery ticket count associated therewith, each lottery ticket of the initial number of lottery tickets issued comprising a plurality of potential winning numbers;
executing an initial round of the lottery game;
determining whether any one of the respective one players of the initial plurality of players is a winner of the initial round of the lottery game executed based on a matching of a specified number of required winning number matches between the plurality of potential winning numbers of a particular one lottery ticket of the initial number of lottery tickets issued thereto with the plurality of winning numbers of the lottery game, and in accordance with the determination:
   if the winner of the lottery game is determined then:
      identifying the particular one lottery ticket of the initial number of lottery tickets issued to the respective one player determined as the winner of the lottery game based on the matching;
      notifying the respective one player determined as the winner of the lottery game of their lottery game win;
      transmitting a lottery prize associated with the lottery game to the respective one player determined as the winner; and
      recording results of the lottery game executed on the DLT ledger;
   otherwise, if the winner of the lottery game is not determined then:
      (a) updating the plurality of winning lottery numbers and redefining the specified number of required winning number matches;
      (b) receiving one or more subsequent lottery ticket requests, each of the one or more subsequent lottery ticket requests associated with a respective one player of a subsequent plurality of players and having a subsequent defined requested total lottery ticket count associated with the respective one player of the subsequent plurality of players, and wherein the subsequent plurality of players comprises all or any portion of the initial plurality of players and any new player joining for any subsequent round and the subsequent defined requested total lottery ticket count may be any number of lottery tickets;
      (c) issuing and recording on the DLT ledger a subsequent number of lottery tickets to each respective one player of the subsequent plurality of players making the one or more subsequent lottery ticket requests in accordance with the subsequent defined requested total lottery ticket count associated therewith, each lottery ticket of the subsequent number of lottery tickets issued comprising a plurality of potential winning numbers;
      (d) defining a current total number of lottery tickets issued for each respective one player of the subsequent plurality of players, the current total number of lottery tickets defined comprising a combination of the initial number of lottery tickets issued to the respective one player and any and all of the subsequent number of lottery tickets issue thereto;
      (e) executing a subsequent round of the lottery game;
      (f) determining whether any one of the respective one players of the subsequent plurality of players is a winner of the subsequent round of the lottery game executed based on a matching of the specified number of required winning number matches redefined between the plurality of potential winning numbers of a particular one lottery ticket of the current total number of lottery tickets defined with the plurality of winning numbers updated, and in accordance with the determination:
      (g) if the winner is identified then:
         identifying the particular one lottery ticket of the current total number of lottery tickets issued to the respective one player of the subsequent plurality of players determined as the winner of the lottery game;
         notifying the respective one player of the subsequent plurality of players determined as the winner of the lottery game of their lottery win;
         transmitting the lottery prize associated with the lottery game to the respective one player of the subsequent plurality of players determined as the winner; and
         recording results of the lottery game executed on the DLT ledger;
         otherwise, if the winner of the subsequent round of the lottery game executed is not determined then repeating steps (a) through (g) until the winner is determined.

In a fourth aspect, a lottery gaming application (alternatively referred to herein as an “app”) is provided for implementing and executing lottery games comprising the operations of at least:
executing a smart contract associated with a lottery game, the lottery game comprising a plurality of winning numbers;
under control of the smart contract executed:
receiving an initial plurality of lottery ticket requests, each initial lottery ticket request associated with a respective one player of an initial plurality of players and having an initial defined requested total lottery ticket count associated with the respective one player;
issuing and recording on a distributed technology ledger (DLT) an initial number of lottery tickets to each respective one player of the initial plurality of players in accordance with the initial defined requested total lottery ticket count associated therewith, each lottery ticket of the initial number of lottery tickets issued comprising a plurality of potential winning numbers;
executing an initial round of the lottery game;
determining whether any one of the respective one players of the initial plurality of players is a winner of the initial round of the lottery game executed based on a matching of a specified number of required winning number matches between the plurality of potential winning numbers of a particular one lottery ticket of the initial number of lottery tickets issued thereto with the plurality of winning numbers of the lottery game, and in accordance with the determination:
   if the winner of the lottery game is determined then:
      identifying the particular one lottery ticket of the initial number of lottery tickets issued to the respective one player determined as the winner of the lottery game based on the matching;
      notifying the respective one player determined as the winner of the lottery game of their lottery game win;
      transmitting a lottery prize associated with the lottery game to the respective one player determined as the winner; and
      recording results of the lottery game executed on the DLT ledger;
   otherwise, if the winner of the lottery game is not determined then:
      (a) updating the plurality of winning lottery numbers and redefining the specified number of required winning number matches;
      (b) receiving one or more subsequent lottery ticket requests, each of the one or more subsequent lottery ticket requests associated with a respective one player of a subsequent plurality of players and having a subsequent defined requested total lottery ticket count associated with the respective one player of the subsequent plurality of players, and wherein the subsequent plurality of players comprises all or any portion of the initial plurality of players and any new player joining for any subsequent round and the subsequent defined requested total lottery ticket count may be any number of lottery tickets;
      (c) issuing and recording on the DLT ledger a subsequent number of lottery tickets to each respective one player of the subsequent plurality of players making the one or more subsequent lottery ticket requests in accordance with the subsequent defined requested total lottery ticket count associated therewith, each lottery ticket of the subsequent number of lottery tickets issued comprising a plurality of potential winning numbers;
      (d) defining a current total number of lottery tickets issued for each respective one player of the subsequent plurality of players, the current total number of lottery tickets defined comprising a combination of the initial number of lottery tickets issued to the respective one player and any and all of the subsequent number of lottery tickets issue thereto;
      (e) executing a subsequent round of the lottery game;
      (f) determining whether any one of the respective one players of the subsequent plurality of players is a winner of the subsequent round of the lottery game executed based on a matching of the specified number of required winning number matches redefined between the plurality of potential winning numbers of a particular one lottery ticket of the current total number of lottery tickets defined with the plurality of winning numbers updated, and in accordance with the determination:
      (g) if the winner is identified then:
         identifying the particular one lottery ticket of the current total number of lottery tickets issued to the respective one player of the subsequent plurality of players determined as the winner of the lottery game;
         notifying the respective one player of the subsequent plurality of players determined as the winner of the lottery game of their lottery win;
         transmitting the lottery prize associated with the lottery game to the respective one player of the subsequent plurality of players determined as the winner; and
         recording results of the lottery game executed on the DLT ledger;
         otherwise, if the winner of the subsequent round of the lottery game executed is not determined then repeating steps (a) through (g) until the winner is determined.

In a further aspect, the DLT ledger is a private blockchain.

In a further aspect, the DLT ledger is a public blockchain.

In a further aspect, the lottery prize transmitted is in either a fiat currency or a cryptocurrency.

In a further aspect, the cryptocurrency is one of: Bitcoin (BTC), Ethereum (ETH), Binance Coin (BNB), Tether (USDT), Solana (SOL), XRP (XRP), Cardano (ADA), USD Coin (USDC), Binance USD (BUSD), and Avalanche (AVAX).

In a further aspect, the lottery prize transmitted is to a digital wallet associated with the winner of the lottery game.

In a further aspect, the redefining the specified number of required winning number matches is a function of a decrease in the specified number of required winning number matches.

In a further aspect, there is receiving a designation of the plurality of winning numbers and/or the plurality of winning numbers updated from a third-party service.

In a further aspect, the third-party service employs a random number generator for generating the plurality of winning numbers and/or the plurality of winning numbers updated.

In a further aspect, the random number generator is a blockchain based verifiable random number generator.

In a further aspect, the random number generator is a blockchain-based verifiable random number generator.

In a further aspect, there is receiving a designation of the plurality of winning numbers from the players making the lottery ticket request.

In a further aspect, there is receiving payment for the initial number of lottery tickets issued to each respective one player of the initial plurality of players and the subsequent number of lottery tickets issued to each respective one player of the subsequent plurality of players. In a further embodiment, the payment received may be made using either a fiat currency or cryptocurrency.

In a further aspect, there is receiving from the winner of the lottery game a currency type for use in the transmitting a lottery prize associated with the lottery game. In a further aspect, the currency type designated is one of a cryptocurrency or a fiat currency.

In a further aspect, the plurality of winning numbers comprise a total of six (6) winning numbers and the specified number of winning number is six (6) for the matches between the plurality of potential winning numbers of a particular one lottery ticket of the initial number of lottery tickets issued thereto with the plurality of winning numbers of the lottery game.

In a further aspect, the plurality of winning numbers are defined by the respective round being played up to a maximum of six (6) winning numbers.

In a further aspect, there is recording the smart contract on the DLT ledger.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a high-level block diagram of a network architecture for providing a blockchain-based lottery gaming system in accordance with an embodiment;

FIG. 2 presents a high-level block diagram for implementing and executing blockchain based lottery games in accordance with an embodiment;

FIG. 3 presents a flowchart showing a high-level lottery gaming methodology for implementing blockchain-based lottery games for a number of players in accordance with an embodiment;

FIG. 4 presents a flowchart of illustrative operations for implementing and executing blockchain-based lottery games for a number of players in accordance with an embodiment;

FIG. 5 presents a flowchart of illustrative operations for user onboarding and subscription in accordance with an embodiment;

FIG. 6 presents a blockchain-based lottery gaming system configured in accordance with an embodiment;

FIG. 7 presents a user device configured in accordance with an embodiment;

FIG. 8 presents an illustrative architecture for a DLT-based lottery gaming system application for implementing and executing blockchain-based lottery games for a number of players in accordance with an embodiment;

FIG. 9 a flowchart showing a high-level lottery gaming methodology for implementing blockchain-based lottery games for a number of players and a one-time buy-in in accordance with an embodiment; and

FIG. 10 a flowchart of illustrative operations for implementing and executing blockchain-based lottery games for a number of players and a one-time buy-in in accordance with an embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a distributed ledger technology (DLT)-based lottery gaming system and method for implementing and executing lottery games among players. More particularly, players are able to participate in a multi-round lottery game offered and executed by the DLT-based lottery gaming system. The lottery game is executed using an associated smart contract and DLT ledger, and the lottery game includes a plurality of winning numbers (e.g., six (6) total). Thus, the players will agree in advance (e.g., either by purchasing a ticket subject to terms and conditions or execute a separate player agreement containing such terms and conditions) to participate in the lottery gaming application and the execution thereof to identify a lottery winner. Under control of the smart contract, the players make an initial plurality of lottery ticket requests such that each initial lottery ticket request associated with a player of has an initial defined requested total lottery ticket count (e.g., five (5) tickets) associated with the player indicating the number of tickets they wish to purchase and to be issued to them. The DLT-based system and method issues and records on the DLT these initial number of lottery tickets issued to each player where each lottery ticket of the initial number of lottery tickets issued includes a plurality of potential winning numbers. A record of the lottery tickets issued and to which players are recorded on the DLT ledger. The lottery game is executed starting with an initial round of the lottery game. That is, the lottery game is a multi-round format allowing for multiple rounds to be executed until a winner is identified. So, if there is no winner identified in this initial round then subsequent rounds are executed to identify a winner. In these subsequent rounds, existing players or new players (but only starting with the subsequent round in which they joined the lottery game) may purchase any number of additional tickets for that subsequent round. Further, in each subsequent round executed the number of required winning numbers for matching the potential winning numbers of the players' tickets is decreased (e.g., decreased by one winning number for each subsequent round). In this way, as multi-rounds are executed the number of winning lottery numbers required to match for a win decreases translating into increasing the odds of winning by any one remaining player. Once a winner is determined, the lottery prize associated with the lottery game is transmitted to that player in either a cryptocurrency or a fiat currency. The results of the executed lottery game are recorded to the DLT ledger Importantly, the DLT-based lottery gaming system and associated method(s) of the disclosed embodiments provide advantageous improvements of practical applications including, but not limited to, lottery gaming platforms, gaming applications and platforms, and blockchain-based transaction systems. Problems associated with lottery game security and the availability of lottery games are addressed by the principles of the disclosed embodiments.

To provide further context for the subject disclosure, a high-level discussion of DLI, blockchains, and smart contracts will now be discussed. Blockchain is a distributed database that records all transactions that have ever occurred in a network, for example. Blockchain was originally introduced for Bitcoin (a peer-to-peer digital payment system), but then evolved to be used for developing a wide range of decentralized applications. A blockchain is a distributed digital ledger which is communicated electronically between hardware devices. Each transaction recorded within the digital ledger is a block which can be hashed or otherwise encrypted. As new transactions are added to the digital ledger, each transaction's veracity can be tested against the previous ledger stored by the devices. In some configurations, there may be a requirement that some fixed percentage (e.g., fifty percent (50%)) of the user devices must confirm the transaction's veracity before being added to the blockchain. As such, a blockchain is a distributed database that records all transactions that have ever occurred in the blockchain network. This database is replicated and shared among the network's participants (or a subset thereof in some implementations). The main feature of blockchain is that it allows untrusted participants to communicate and send transactions between each other in a secure way without the need of a trusted third party. In this way, blockchain is an ordered list of blocks, where each block is identified by its cryptographic hash. Each block references the block that came before it, resulting in a chain of blocks. Each block consists of a set of transactions. Once a block is created and appended to the blockchain, the transactions in that block cannot be changed or reverted. This is to ensure the integrity of the transactions, for example, the smart contract execution governing the lottery game between multiple players and employing the DLT for the lottery game's execution in accordance with the principles of the embodiments herein.

In essence, as noted previously, a blockchain is a transaction ledger that maintains identical copies across each computer of a member network and the fact that the ledger is distributed across part of the network facilitates the security of blockchain. A blockchain relies on three important components: private key technology, a distributed network that includes a shared ledger, and an accounting means for the transactions and records across the network A blockchain is a list of records that are cryptographically linked together such that each block of the blockchain contains a cryptographic hash of the previous block, a timestamp, and transaction data. Thus, a blockchain is highly resistant to date modification due to the design feature that once recorded the data in any given block cannot be altered without alteration of all subsequent blocks In many applications, the constructed distributed ledger is managed within a peer-to-peer network that allows participants to verify and audit transactions in an efficient manner. By combining the use of cryptographic keys with a distributed network, blockchain expands the type and number of digital transaction possibilities.

One appealing application that can be deployed on top of blockchain are so-called smart contracts. A smart contract is executable code that runs on the blockchain to facilitate, execute, and enforce the terms of an agreement between parties (e.g., the lottery game participation and execution hereunder). It can be thought of as a system that releases digital assets to all or some of the involved parties once the pre-defined rules have been met. The main aim of a smart contract is to automatically execute the terms of an agreement once the specified conditions are met. Before a smart contract may process transactions, the smart contract must be deployed on the blockchain. The deployment process must guarantee that all blockchain nodes have exactly the same program code. Generally, blockchain designs employ two smart contract deployment approaches. One approach is to save the smart contract code itself in the blockchain thereby guaranteeing global node consensus (so-called “on-chain”), and the other is to allow each node owner to decide if the node should have the code installed locally and use a hash-based commitment in the blockchain as reference for validating the integrity thereof (so-called “off-chain). Smart contracts are executed by the blockchain nodes, as a result of processing transactions that are submitted by the user. A blockchain transaction has a designated smart contract function and a payload that contains input values to the function call. A transaction may be submitted at any node in the blockchain network, which broadcasts the transaction to the entire network, so all of the nodes are aware of the transaction. At a particular point, the transaction is processed by each of the nodes using the executable program code in the target smart contract. If the transaction is successful, the internal state of the blockchain will be updated. If the trigger input is determined to be invalid and rejected by the smart contract, then the overall state is not affected. For example, the smart contract may be triggered by a specific event (“if A happens, then action B”). In this way, a smart contract functions as a trusted distributed application that gains security/trust from the blockchain and the underlying consensus among the peers. Smart contracts must be independently executed by a quorum of blockchain nodes Unlike traditional database structures, blockchains are decentralized such that every node assumes other nodes are potentially malicious and a node never trusts states maintained by other nodes in the network. Instead, each node maintains their own state database by executing the transaction itself using the smart contract code. Thus, each smart contract maintains their own set of states and transactions submitted to a blockchain may target a smart contract. Once a transaction is executed, the target smart contract updates its state and one smart contract may call another smart contract in order to query, for example, the downstream smart contract's state or update the same. Only valid transactions result in updated states and invalid transactions are either rejected by the blockchain network from being included in the blockchain or included but marked as failed depending upon the particular blockchain design. In this way, the deployed smart contract serves as a form of execution logic for a blockchain application. Thus, smart contracts promise low transaction fees compared to traditional systems that require a trusted third party to enforce and execute the terms of an agreement. There are different blockchain platforms that can be utilized to develop and deploy smart contracts, and Ethereum is a common platform for developing smart contracts. In accordance with the principles of the disclosed embodiments hereunder, the smart contracts may be executed using a private DLT or a public DLT.

Ethereum is a public blockchain platform that can support advanced and customized smart contracts with the help of Turing-complete programming language. Ethereum is a decentralized blockchain platform that establishes a peer-to-peer network that securely executes and verifies application code (e.g., smart contracts). Ethereum is a platform powered by blockchain technology that may be best known for its native cryptocurrency, called ether (or ETH), or simply Ethereum. In this way, a user/sender must sign transactions and spend ETH as a cost of processing transactions on the network. Smart contracts, as previously noted, allow participants to transact with each other without a trusted central authority. Transaction records are immutable, verifiable, and securely distributed across the network, giving participants full ownership and visibility into transaction data. Transactions are sent from and received by user created Ethereum accounts. Ethereum offers an extremely flexible platform on which to build decentralized applications using the native Solidity scripting language and Ethereum Virtual Machine (EVM). The code of Ethereum smart contracts is written in a stack-based bytecode language and executed in the EVM. Several high-level languages (e.g., Solidity and Serpent) can be used to write Ethereum smart contracts. The code of those languages can then be compiled into EVM bytecodes to be executed. Decentralized application developers who deploy smart contracts on Ethereum benefit from the rich ecosystem of developer tooling and established best practices that have come with the maturity of the protocol. This maturity also extends into the quality of user-experience for the average user of Ethereum applications, with digital/cryptocurrency wallets such as MetaMask, Argent, Rainbow, and more offering simple interfaces through which to interact with the Ethereum blockchain and smart contracts deployed thereon. Ethereum's large user base encourages developers to deploy their applications on the network, which further reinforces Ethereum as the primary platform for decentralized applications like decentralized finance (DeFi), decentralized applications (dApps), and non-fungible tokens (NFTs). The distributed nature of blockchain technology is what makes the Ethereum platform secure, and that security enables ETH to accrue value.

Another blockchain platform that is increasingly gaining traction is the Hyperledger Fabric (also referred to as “Fabric”) as established by the Linux Foundation (see, e.g., LFS272: Hyperledger Fabric Administration, version 8.24, dated May 26, 2021) with a major focus on enterprise uses that require participants to be identified/identifiable, permissioned networks, high transaction throughput performance, low latency of transaction confirmation and privacy and confidentiality of transactions and data pertaining to business transactions. Fabric is the first distributed ledger platform to support smart contracts authored in general-purpose programming languages such as Java, rather than domain-specific languages (DSL). As such, enterprises can more easily develop smart contracts without the need to learn a specific/new programming language. The Fabric platform is also permissioned in that, unlike a public permissionless network, the participants are known to each other, rather than anonymous and therefore fully untrusted. This means that while the participants may not fully trust one another (e.g., if they are adverse parties or competitors) a network can be operated under a governance model that is constructed as a function of whatever trust does exist between participants, such as a legal framework. These features make Fabric one of the better performing platforms that are currently available both in terms of transaction processing and transaction confirmation latency. Further, this platform enables privacy and confidentiality of transactions and smart contracts that implement them.

Fabric has been specifically designed with a modular architecture making it very adaptable and customizable for various use cases. The modular components include (i) a pluggable ordering service that established consensus on the order of transactions and then broadcasts blocks to peers; (ii) a pluggable membership service provider that is responsible for associating entities in a network with cryptographic identities; (iii) smart contracts (so-called chain code) run within a contained environment for isolation and can be written in standard programming languages; (iv) the ledger can be configured to support a variety of database management systems (DBMS); and (v) a pluggable endorsement and validation policy enforcement can be independently configured per application.

Further, encrypted data in the form of NFTs may be employed across a blockchain. As will be appreciated, an NFT is a unit of data stored on a digital ledger (as described above), that certifies a digital asset to be unique and therefore not interchangeable. NFTs are digital assets that can be used to represent items including, not limited to, photos, videos, audio, property, and other types of digital files. Currently, NFTs are bought and sold online, frequently with cryptocurrency, and they are generally encoded with the same underlying software as many cryptocurrencies. Access to any copy of the original file, however, is not restricted to the owner of the NFT. While copies of these digital items are available for anyone to obtain, NFTs are tracked on a blockchain to provide the owner with a proof of ownership that is separate from a copyright, for example. That is, an NFT is a unit of data stored on the digital ledger (e.g., the blockchain), which can be sold, traded and/or transferred. The NFT can be associated with a particular digital or physical asset (such as a file or a physical object) and a license to use the asset for a specified purpose or for transferring the ownership of the asset from one owner to another. NFTs (and the associated license to use, copy or display the underlying asset or the ownership assignment thereof) can be traded and sold on digital markets In this way, NFTs function like cryptographic tokens, but, unlike other tokens (e.g., Bitcoin), NFTs are not mutually interchangeable, hence not fungible. Thus, each NFT may represent a different underlying individual asset and thus have a different value. NFTs are created, for example, when blockchains string records of cryptographic hash a set of characters identifying a set of data onto previous records thereby creating a chain of identifiable data blocks. This cryptographic transaction process ensures the authentication of each digital file by providing a digital signature that is used to track NFT ownership. An NFT is a unique digital token, with most using, for example, the above-referenced Ethereum blockchain to digitally record transactions. Again, the NFT is not a cryptocurrency like Bitcoin or Ethereum, because those are fungible (i.e., exchangeable for another Bitcoin or cash). However, NFTs are recorded in the digital ledger in the same way as cryptocurrency, so there is a listing of who owns each one. In this way, blockchains act as a decentralized system for recording and documenting transactions that involve a specific NFT and/or a plurality of NFTs. In essence, as noted previously, a blockchain is a transaction ledger that maintains identical copies across each computer of a member network and the fact that the ledger is distributed across part of the network facilitates the security of blockchain.

As will be appreciated, transacting smart contracts and NFTs carries an associated expense when using Ethereum. “Gas” refers to the computational effort required to execute operations on the blockchain, and any user must pay a gas fee in order to make transactions or executed smart contracts on Ethereum, for example. Further, gas is the term given to the fee that most NFT trading platforms charge. Thus, gas fees are incurred to conduct the transaction or execute a smart contract on their blockchain platform. For example, gas prices in Ethereum are denoted by a unit of gwei, which itself is a denomination of ether (ETH) that is the native cryptocurrency of the Ethereum platform. Each gwei is equal to 0.000000001 ETH. For example, instead of designating that the user's gas costs 0.000000001 ether, this translates to a cost of 1 gwei. The valuation is determined by the amount of traffic on the network and the computation power taken to execute a transaction. Gas fees are payments that users have to make to compensate for the computation energy required to process transactions on the Ethereum blockchain. Ethereum implements something called the proof of work algorithm. In this blockchain, validators who use special algorithms (called miners) solve cryptographic problems. Finding a successful solution to this problem enables sets of transactions to be processed and added to the blockchain. Everything on the Ethereum network costs some denomination of gas. Interestingly, one difference with respect to Hyperledger Fabric is that the Fabric platform does not currently have any native token or cryptocurrency in the system. So, a user currently does not need to have cryptocurrency in order to use this platform and there is no notion of gas. Gas on the Ethereum network is assigned a market price based upon the demand for resources in the network at a particular moment in time. Therefore, the valuation of Ethereum gas depends upon the supply and demand in the network. If there is high demand for transactions, this requires more miners to complete complicated algorithms creating more work and energy consumption; hence increasing the gas fee. If the gas price does not meet the threshold power, it cannot process the transactions. The user may decide the maximum gas amount they want to spend on a transaction and may set a limit on the gas price expended and wait until such price reaches that limit. This ensures that a user has some control over the transaction expenses. For example, if a user is willing to wait then the transaction will get processed when the gas limit set has been reached. The main criteria for gas expenses will depend upon the size of the smart contract for execution on the blockchain as well as the speed at which the user wants that transaction to be completed.

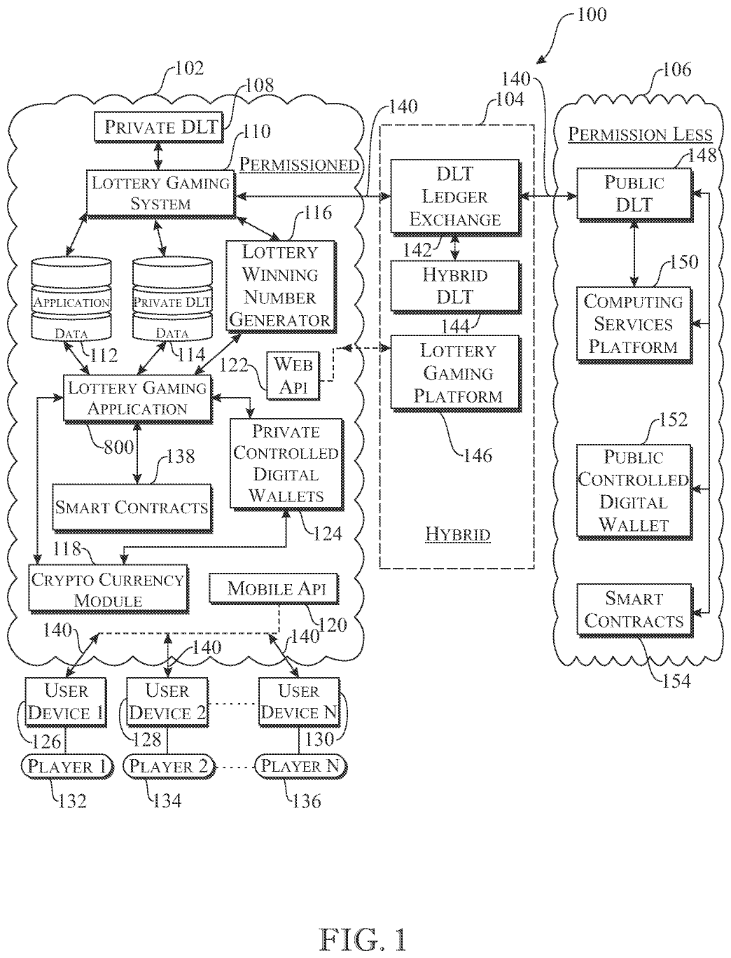

Turning our attention to FIG. 1, a high-level block diagram is presented of cloud network services architecture 100 comprising a plurality of platforms implemented in accordance with an embodiment of the invention. More particularly, a private cloud environment 102 for implementing a permissioned, i.e., private DLT 108 (e.g., a private blockchain) that is controlled by a single authority, a public cloud environment 106 for executing a permissionless, i.e., public DLT 148 (e.g., a public blockchain), and a hybrid cloud environment 104 for implementing a hybrid DLT 144 that is controlled by a single authority but with a level of oversight by the public DLT 148, for example, such that communications and/or data and other information associated with one or more private DLTs 108 and one or more public DLTs 148 may be exchanged through DLT ledger exchange 142 across the hybrid DLT 144 of the hybrid cloud environment 104. In this way, the private cloud environment 102, the hybrid cloud environment 104, and/or the public cloud environment 106 may be employed to deliver the DLT-based lottery gaming system and method for implementing lottery game execution among a number of players in accordance with the principles of the disclosed embodiments. As will be appreciated, the cloud network services architecture 100 may comprise a plurality of servers, access points and databases in the operation and execution of the respective cloud environments. For avoidance of doubt, as used herein, a public blockchain broadly refers to a blockchain that has been implemented as a permissionless blockchain, meaning anyone can read or write to the blockchain. One advantage of such a public blockchain is it allows individuals who do not know each other to trust a shared record of events without the involvement of an intermediary or third party. Conversely, a private blockchain broadly refers to a permissioned blockchain where the blockchain's participants are known and are granted read and write permissions by an authority that governs the use of the private blockchain.

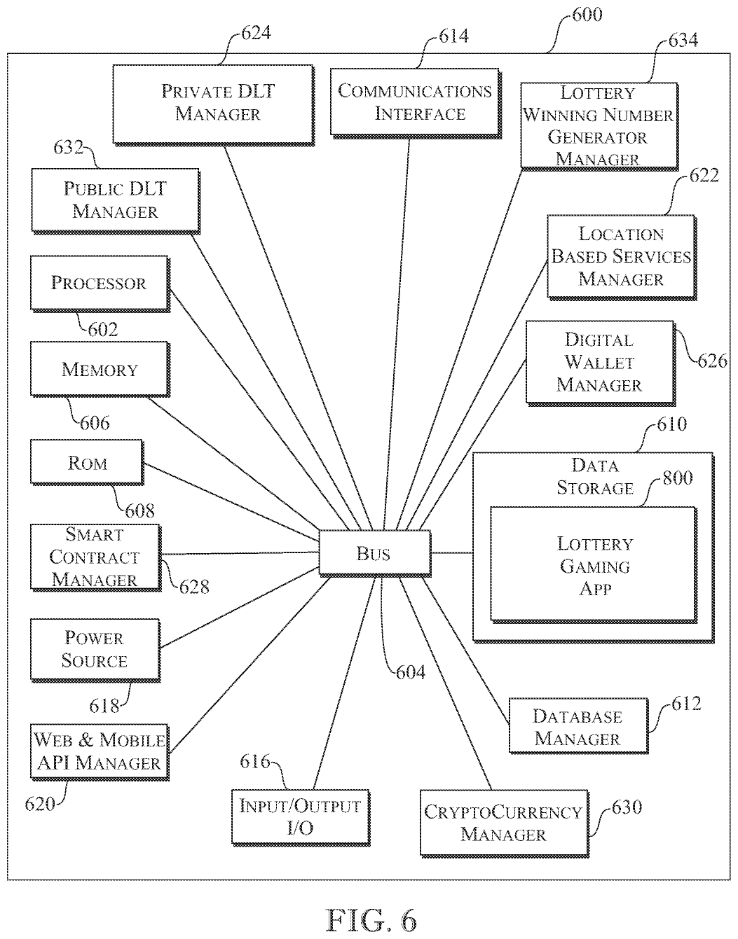

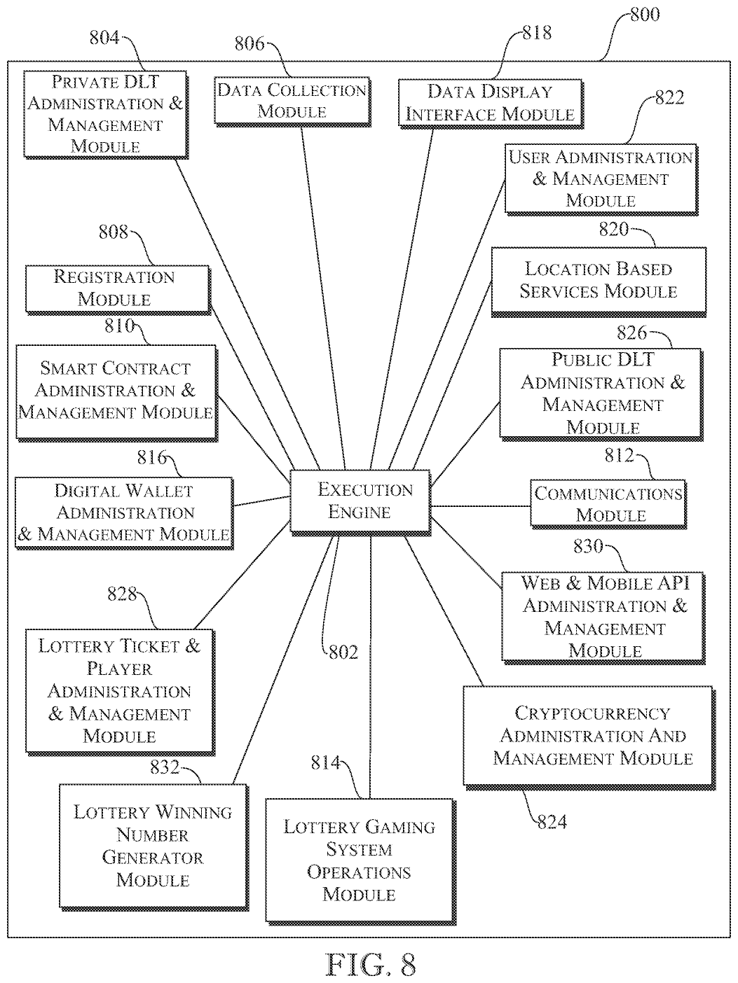

Illustratively, in addition to the private DLT 108, the private cloud environment 102 comprises lottery gaming system 110 (a DLT-based system configured in accordance with lottery gaming system 600 as shown in FIG. 6 in an embodiment and discussed in greater detail herein below) that may employ one or more data and information repositories such as application data 112 and private DLT data 114, in the execution of lottery gaming application 800 (see, FIG. 8). The lottery gaming application 800 is an application that when executed will deliver a multi-round lottery game for participation among a number players until a winner is declared, as discussed in detail herein. As noted, the private DLT 108 in an embodiment is a private/permissioned blockchain(s) (which may also be referred to as a managed blockchain(s)) controlled by a single organization (in this case, for example, the provider and/or administrator of the lottery gaming system 110 and/or the lottery gaming application 800). In a private blockchain, the central authority determines who can be a node and the central authority also does not necessarily grant each node with equal rights to perform functions. As such, the private DLT 108 has several advantages, including the use of cryptographic approaches known to those of skill in the art for identity management and verification of transactions thereby providing protection against malicious activities intended to compromise a transaction by changing the transaction's details. Moreover, permission controls typically associated with private blockchains can provide dynamic control over who can connect, send, receive, and enact individual transactions, based upon any number of parameters that may not be available or implementable in public blockchains. Accordingly, full control can be asserted over every aspect of a blockchain's operation, not only in accordance with the consensus of its various participants, but the blockchain's administrative intermediary as well.

Private blockchains are only partially decentralized because public access to these blockchains is restricted. Some examples of known private blockchains are the business-to-business virtual currency exchange network Ripple, R3's Corda, and Hyperledger, an umbrella project of open-source blockchain applications (as noted herein above). These are permissioned systems which, in the case of Corda and Hyperledger, restrict access to transaction data to the parties involved in that transaction, rather than the data being made public in a public ledger like Bitcoin. Illustratively, the private DLT 108 is a private blockchain architecture designed using Hybrid Fabric or Hyperledger Besu which is an open-source Ethereum client developed for enterprise applications requiring secure, high-performance transaction processing in a private network as well as lottery gaming app 800 which is designed, in an embodiment, as a mobile-based app architecture. As will be appreciated, Hyperledger Besu may be used to connect to a public network (e.g., the existing public Ethereum network) and may be configured to perform as a full node that synchronizes to the blockchain and an archive node, which contains the data of the blockchain but does not participate in adding new blocks. Besu can also be used to create a private blockchain network (e.g., the private DLT 108), compatible to the Ethereum Virtual Machine (EVM), for customized blockchain applications including, but not limited to, the lottery gaming application 800.

As will be appreciated, a mesh network may be employed between various parties for various purposes hereunder. For example, an illustrative mesh network may employ a peer-to-peer configuration that includes six (6) nodes between a plurality of parties. In this example, node A is associated with the party 1, node B is associated with the party 2, node C is associated with party 3, node D is associated with party 4, node E is associated with party 5, and node F is associated with party 6. This illustrative mesh network is configured such that each node can communicate with and relay data to each of the other nodes. In this way, the various parties (e.g., the individual lottery game players) may use their respective user devices (e.g., the user device 1 126) to communicate with each other across the mesh network in performing the various operations and/or actions required by the lottery gaming system 110 and lottery gaming app 800 processing. Of course, this illustrative configuration is only one of many different possibilities that may be utilized to deploy the smart contracts, for example, across the private DLT in accordance with the principles of the disclosed embodiments.

As noted above, in the framework of the principles of the disclosed embodiments, a blockchain is a public ledger of all transactions that have been executed in a particular context (e.g., the lottery gaming application hereunder). The blockchain constantly enlarges as completed blocks are added thereto as new transactions are addressed. Typically, blocks are added to the blockchain in a linear, chronological order by the various user devices involved in the transaction(s) and are interconnected in executing the blockchain protocol, for example, in a peer-to-peer network. The peer-to-peer network is essentially a plurality of interconnected nodes (e.g., node A, node B, node C, node D, node E, and node F) with each node associated with a particular user device the employs a client to validate and relay transactions.

In this way, the blockchain is distributed among multiple devices associated with multiple parties. For example, party A, party B, party C, party D, and party E. In this example, a block 1 is added to the blockchain by party A and may contain the party ID of party A or an address/identification of the user device associated and used by the party A, and may also contain data (e.g., relevant smart contract transaction data). Also, the block 1 may contain an authentication portion that may be used to set restrictions of various levels on the data and/or the party ID. For example, the party ID and the data may be set such that they are not accessible to one or more of the other parties. This may be advantageous if party A, for example, does not want party D to have access to certain of the data. The data may be part of one of the smart contracts employed by the blockchain-based lottery gaming system 110 and associated operations in applying smart contract transactions processing hereunder. In turn, the smart contract is stored on the blockchain and executed automatically as part of the respective transactions executed. As the user device(s) generate additional blocks, each such block is hashed into the previous blockchain resulting in an updated blockchain which continues to be distributed among the various parties and their respective user devices. The blockchain protocol may include a so-called proof of work scheme that is based on a cryptographic hash function (CHF), for example, the secure hash algorithm 256 (SHA-256). Generally, the CHF receives information as input and provides a hash value output, wherein the hash value has a predetermined length. For example, SHA-256 provides a 256-bit (32-byte, 64 character) hash value output. The blockchain may also require multiple information pieces as input to the CHF The input, for example, may include a reference to the previous (i.e., most recent) block in the blockchain, details of the transaction(s) that are to be included in the to-be-created block, and a nonce value (e.g., a random number used a single time). Further, the blockchain protocol provides a threshold hash to qualify a block to be added to the blockchain. For example, the threshold hash may include a predefined number of zeros (0's) that the hash value must have at the start, and the higher the number the more effort that is required to arrive at the qualifying hash. Accordingly, similar to party A, parties B, C, D and E may generate additional blocks, respectively, that are hashed into the blockchain which results in a further updated blockchain that is distributed to the respective use devices of the various engaged parties. In an embodiment, the public DLT 148 is provided using a computing services platform 150 administered by Amazon Web Services (AWS), but other such computing services platforms may also be used (e.g., Microsoft Azure, and Google Cloud).

The principles of the disclosed embodiments, as will be further discussed herein, contemplate the definition, administration and use of cryptocurrencies with the lottery gaming system 110 and the lottery gaming app 800. Such cryptocurrencies will be utilized for paying out any lottery prize to the winning player using the lottery gaming application 800. In a further embodiment, a fiat currency may be utilized for such lottery prize winner payouts. As will be appreciated, digital currency is a currency form that is available in electronic or digital form, but not in physical form. Digital currencies exist and are only accessible with electronic devices, for example, computers and smartphones. That is, digital currencies are intangible and are owned and transacted by using computers or electronic wallets that have access to specifically designated computer networks. Digital currencies have all the intrinsic properties of physical currency (e.g., banknotes or minted coins) and allow for instantaneous transactions that are seamlessly executed for making payments across borders and geographic boundaries when the parties are interconnected to supported hardware devices and networks. Cryptocurrencies have emerged as the first generation of blockchain technology. Cryptocurrencies are basically digital currencies that are based on cryptographic techniques and peer-to-peer networks Today, a number of digital currencies variants, regulated or unregulated, exist such as cryptocurrencies and virtual currencies. A cryptocurrency is another form of digital currency that uses cryptography to secure and verify transactions and to manage and control the creation of new currency units. Currently, cryptocurrencies are unregulated so they may also be considered so-called virtual currencies. That is, virtual currencies are an unregulated digital currency that is controlled by its developers, a founding organization, or a defined network protocol. To be clear, the principles of the disclosed embodiments apply equally to any type of digital currency including, but not limited to, a cryptocurrency, a virtual currency, a central bank digital currency (CBDC), and a digital currency electronic payment (DCEP). In an aspect, currently available public cryptocurrencies may be used including, but not limited to, Bitcoin (BTC), Ethereum (ETH), Binance Coin (BNB), Tether (USDT), Solana (SOL), XRP (XRP), Cardano (ADA), USD Coin (USDC), Binance USD (BUSD), and Avalanche (AVAX).

In various embodiments, the lottery gaming system 110, the private DLT 108 and the lottery gaming app 800 allow for the use of the cryptocurrencies (as managed using cryptocurrency module 118, for example) pursuant to one or more smart contracts (e.g., smart contracts 138 and/or smart contracts 154), for example, with each user assigned at least one private digital wallet of the plurality of private controlled digital wallets 124. In an aspect, one or more of the private controlled digital wallets 124 is configured as an Ethereum wallet. In another aspect, one or more public controlled digital wallets 152 accessed through the public DLT 148 are utilized. In this way, in an embodiment, there is the providing, by the lottery gaming system 110 using the private DLT 108 and/or the public DLT 148, a plurality of digital wallets, wherein each digital wallet of the plurality of wallets being specific to one of the plurality of users (i.e., the players involved in a lottery game by executing lottery gaming app 800). For example, in an aspect, the associated lottery prize award may be distributed to the respective one private digital wallet of the associated winning party and taken from the respective one private digital wallet associated with the sponsor/administrator of the lottery game itself. In this way, the digital wallets provide for the exchange of cryptocurrency between the parties participating in the lottery gaming services hereunder.

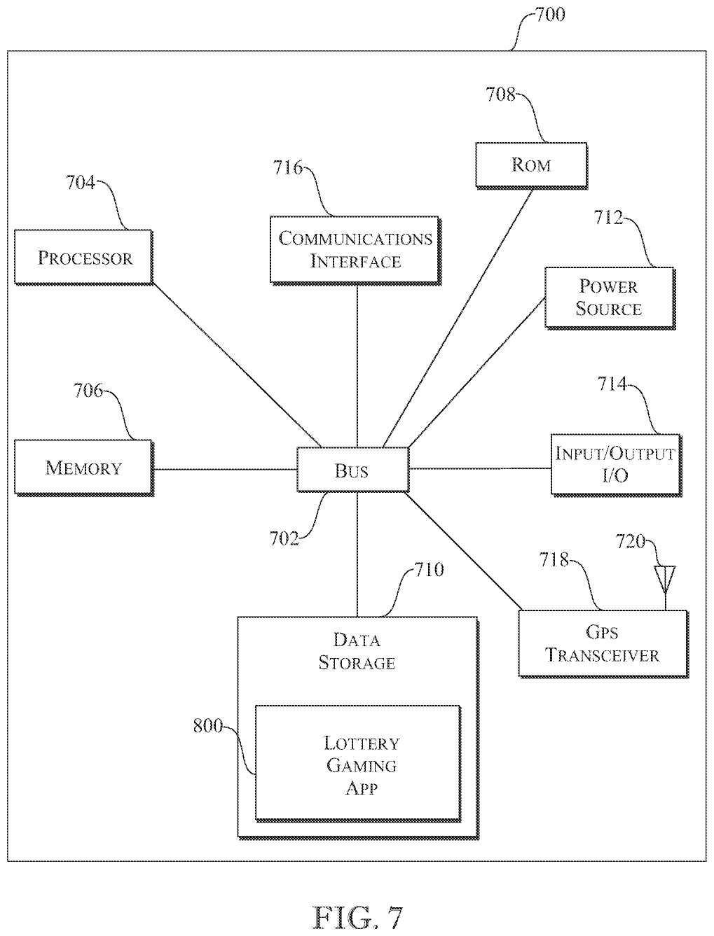

In the embodiment shown in FIG. 1, a plurality of users (i.e., player 1 132, player 2 134 through player N 136) engage with the lottery gaming system 110, the private DLT 108 and the lottery gaming app 800 deployed on the private cloud environment 102 using a respective user device of a plurality of user device (i.e., user device 1 126, user device 2 128 through user device N 130) where one or more of such user devices are configured in accordance with user device 700 (as shown in FIG. 7), as further detailed herein below. Further, in an embodiment, the lottery gaming app 800 is configured to execute as mobile applications managed by and through mobile application programming interface (API) 120. Communications are facilitated across communications links 140 of the cloud network services architecture 100 in accordance with any number of well-known communications protocols and methods (e.g., wireless communications). This may take the form, for example, of a wide area network connection that communicatively couples the lottery gaming system 110 and/or the user devices 126, 128 and 130 with one or more access points which may be a cellular communications service. Similarly, communications managed may take the form, for example, of a local Wi-Fi network interface or Ethernet interface for communicatively coupling with the well-known Internet.

The public cloud environment 106 comprises the public DLT 148. As will be appreciated, this permissionless network allows anyone to join and is completely decentralized. For example, public blockchains allow all nodes of the blockchain to have equal rights to access the blockchain, create new blocks of data, and validate blocks of data. One popular and mainstream use of public blockchains is for exchanging and mining cryptocurrency. On these public blockchains, the nodes “mine” for cryptocurrency by creating blocks for the transactions requested on the network by solving cryptographic equations. In return for this hard work, the miner nodes earn a small amount of cryptocurrency (e.g., the aforementioned gas fees). As shown in FIG. 1, the public cloud environment 106 comprises at least the pubic DLT 148, computing services platform 150, public controlled digital wallets 152, and smart contracts 154 (executed across the public DLT 148). Illustratively, the computing services platform 150 provides necessary processing and storage functionality for the public DLT 148 (e.g., a blockchain), and may include a platform such as Amazon Web Services, Microsoft Azure, and Google Cloud computer for implementing the public DLT 148 comprised by the public cloud environment 106. As noted above, the hybrid cloud environment 104 comprises the DLT ledger exchange 142 for facilitating communications by and between the private DLT 108, the public DLT 148 and the hybrid DLT 144.

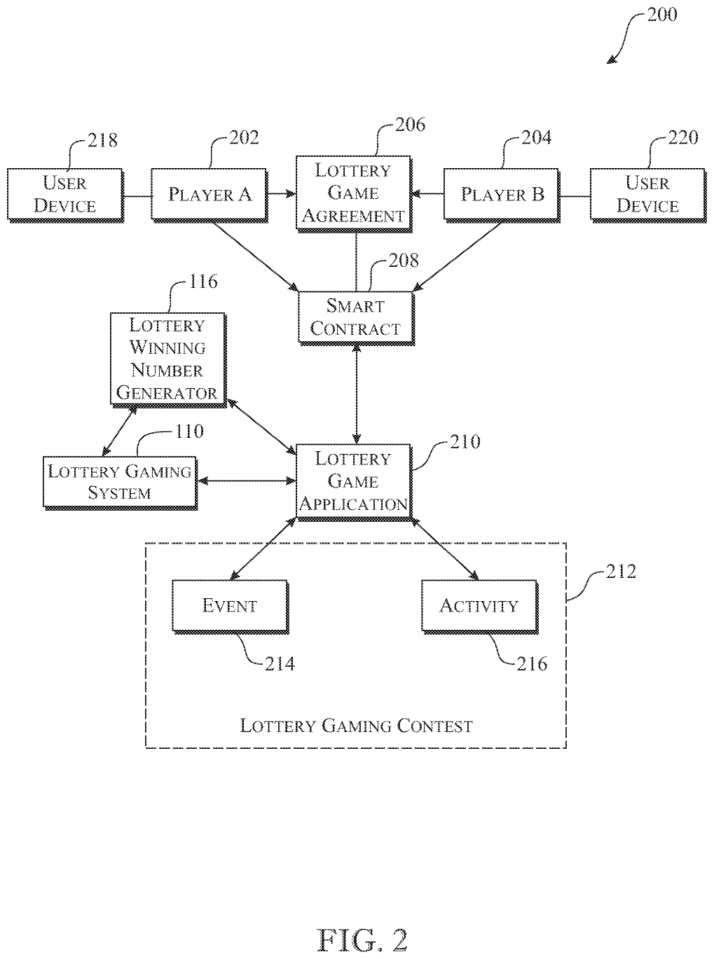

Turning our attention to FIG. 2, a high-level block diagram 200 is shown for implementing and executing blockchain-based lottery games among a number of players in accordance with an embodiment. For clarity, the detailed discussion herein will focus on a blockchain-based implementation. However, any DLT-based implementation may be effectively utilized in accordance with principles of the disclosed embodiments herein. As shown in FIG. 2, party A 202 (e.g., the player 1 132) and party B 204 (e.g., the player 2 134) desire to play a lottery game (or games) and will enter into a lottery game agreement 206 to codify their agreement to engage in the lottery gaming principles of the disclosed embodiments. The lottery game agreement 206 may comprise elements including, but not limited to, an express consent by each party to submission the lottery game execution carried out by the lottery game application 210 (e.g., as configured in the lottery gaming application 800) and to adhere to the final lottery results, a lottery prize award to be distributed to the winning player, various indemnifications (e.g., an indemnification in favor of the administrator of the lottery gaming system 110) and the specification of the gaming context 212 that may involve one or more events 214 and/or activities 216. As such, the gaming context 212 pertains to and assists in defining the lottery game to be executed for declaring a winning player through the execution of the lottery game application 210. Illustratively, in the embodiment shown, the lottery game application 210 (e.g., lottery gaming app 800) operates in conjunction with the lottery gaming system 110 to execute one or more lottery games. That is, multiple lottery games may be executed in a concurrent fashion if desired.

In accordance with principles of the disclosed embodiment, the lottery game application 210 and the execution thereof will be utilized by the players in an effort to win the a lottery prize based on the outcome of the lottery game application 210 as played by the players to the lottery game (e.g., the party A 202 employing user device 218 and party B 204 employing user device 220). In an embodiment, lottery gaming app 800 is one such lottery game application 210 that may be utilized for offering and executing the lottery game among the interested players. Further, in an embodiment, lottery winning number generator 116 may be employed to supply the lottery numbers to be used as the winning numbers for matching against the issued lottery tickets to the different players. To promote security, independence, and confidence in the lottery game's execution, a third-party service may be used to provide the winning numbers as managed by lottery winning number generator 116. Further, in an embodiment, the random number generator is a blockchain-based verifiable random number generator (e.g., the well-known RANDAO random number generator that operates on the Ethereum blockchain). Alternatively, the lottery gaming system 110 and the lottery winning number generator 116 may be configured to generate the requisite winning lottery numbers directly (i.e., no third-party involvement) for each round of the lottery game executed on behalf of the administrator/sponsor of the lottery game and the operator of the lottery gaming system 100. Illustratively, lottery gaming app 800 will offer a multi-round lottery game in accordance with the principles of the disclosed embodiments. The aforementioned lottery game agreement 206 will also serve to trigger the creation of at least one smart contract 208 that will govern the execution of the lottery game application 210 and ultimately the recording of the final lottery results on at least one the DLT ledger (e.g., a blockchain) and the issuance of the associated lottery prize award (e.g., a monetary award) to the winning player. In this way, given the immutable nature of blockchains, the recordation of the final lottery results and the associated lottery game prize is permanent (and time stamped) and cannot be altered, deleted, or destroyed absent some large-scale calamity/failure of the blockchain itself.

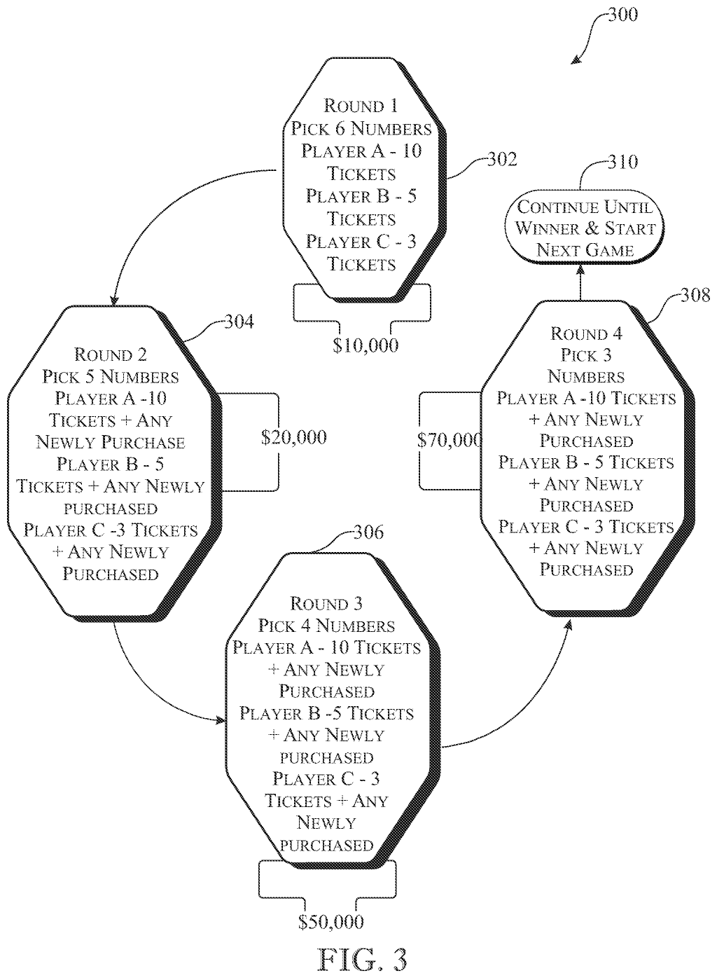

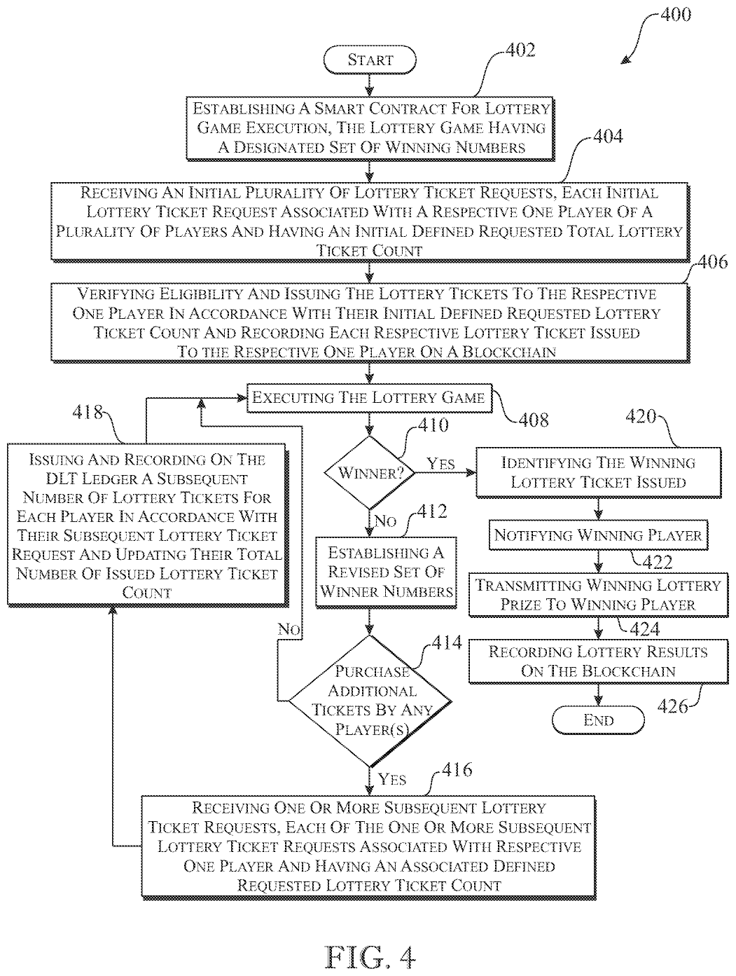

Turning our attention to FIGS. 3 and 4 which will now be discussed together, a flowchart showing a high-level lottery gaming methodology 300 is shown in FIG. 3 for implementing blockchain-based lottery games for a number of players in accordance with an embodiment, and a flowchart of illustrative operations 400 is shown in FIG. 4 for implementing and executing blockchain-based lottery games for a number of players in accordance with an embodiment. More particularly, at step 402, establishing a smart contract for lottery game execution wherein the lottery game comprises a designed set of winning numbers (e.g., a set of six (6) numbers that must be matched in order to win the lottery game). In an embodiment, the plurality of winning numbers comprise a total of at least three (3) winning numbers. The smart contract may be recorded on the DLT ledger (e.g., the private DLT 108 and/or the public DLT 148) as well as part of this establishing step. Further, in an embodiment, the smart contract (e.g., the smart contract(s) 138) may be created by the lottery gaming system 110. Each lottery game may have an associated lottery game identification (ID) and lottery drawing schedule (e.g., a drawing date and one hour in between drawing rounds), a set of rules, and lottery ticket purchase cut-off time after which no further lottery tickets will be issued. In this way, the players may be presented (e.g., on a display of their user device) with a listing of available lottery games to choose from. At step 404, receiving an initial plurality of lottery ticket requests, each initial lottery ticket request associated with a respective one player of an initial plurality of players and having an initial defined requested total lottery ticket count associated with the respective one player. As part of step 404, there may also be a verification that the lottery ticket request is from an eligible player (e.g., must be eighteen (18) years or older). In accordance with principles of the disclosed embodiments, a player may request, purchase and be issued any number of lottery tickets (i.e., there is no minimum or maximum). Each lottery ticket may have a designated purchased price (e.g., $10.00). In an embodiment, there is also a receiving payment for the initial number of lottery tickets issued to each respective one player of the initial plurality of players where the payment received may be in a fiat currency or a cryptocurrency. Illustratively, payments may be made using a checking account or debit card. In an embodiment, there is a receiving a designation of the plurality of potential winning numbers for at least one lottery ticket of the initial number of lottery tickets issued from the respective one player of the initial plurality of players associated with the initial lottery ticket request therefore. Further, in an embodiment, there is receiving a designation of the plurality of potential winning numbers from a third-party service for at least one lottery ticket of the initial number of lottery tickets issued and the subsequent number of lottery tickets issued. In this way, the numbers for the lottery tickets issued may be chosen directly by the player and/or the third-party service. In accordance with the principles of the disclosed embodiments, each initial lottery ticket issued to any one player will be valid for the initial lottery round executed and any subsequent round executed, as further detailed herein below.

At step 406, issuing and recording on the DLT an initial number of lottery tickets to each respective one player of the initial plurality of players in accordance with the initial defined requested total lottery ticket count associated therewith, each lottery ticket of the initial number of lottery tickets issued comprising a plurality of potential winning numbers. Once issued the lottery tickets issued to any one player are secured by lottery gaming system 110 such that only that player may view and access their respective issued lottery tickets. This increases overall lottery game security and confidence that the lottery games are executed in a fair and transparent fashion. Then, at step 408, executing the lottery game That is, a multi-round lottery game is executed in accordance with a preferred embodiment and the lottery game's execution begins with an initial round. As noted above, the winning numbers for each game are generated and provided by the lottery winning number generator 116 (either independently by the lottery gaming system 110 and/or the lottery number generator 116 itself, or as provided by a third-party service). At step 410, determining whether any one of the respective one players of the initial plurality of players is a winner of the initial round of the lottery game (see, e.g., round 1 302 in FIG. 3) executed based on a matching of a specified number of required winning number matches between the plurality of potential winning numbers of a particular one lottery ticket of the initial number of lottery tickets issued thereto with the plurality of winning numbers of the lottery game. Illustratively, in the execution of this initial round the specified number of required winning numbers is equal to the plurality of winning numbers associated with the lottery game at the outset (e.g., six (6) numbers). If a winner is determined based on the matching, then at step 420, identifying the particular one lottery ticket of the initial number of lottery tickets issued to the respective one player determined as the winner of the lottery game based on the matching, and notifying, at step 422, the winner of their lottery game win. Such notification may come in a variety of forms (e.g., telephone call, electronic mail, text message, etc.) At step 424, transmitting a lottery prize (e.g., $10,000) associated with the lottery game to the winner and recording, at step 426, the lottery results on the DLT ledger (e.g., a blockchain). Then, closing out the DLT ledger and the operations end. In an embodiment, there may be a receiving from the winner of the lottery game a currency type for use in the transmitting a lottery prize associated with the lottery game, and the currency type may be a fiat currency or a cryptocurrency That is, the player may designate the currency in which they wish to receive their lottery winnings (such designation may be made either before or after execution of the lottery game). In an embodiment, the DLT-based lottery gaming system using the private DLT, provides a plurality of private digital wallets (e.g., the private controlled digital wallets 124), wherein each private digital wallet of the plurality of private wallets being specific to a respective one player of the plurality of players. In this way, the lottery prize may be distributed to the private wallet of the winning party. Thus, in an embodiment, the lottery prize is distributed by a DLT-based lottery gaming system (e.g., the lottery gaming system 110) using a private digital wallet (e.g., the private controlled digital wallets 124) specific to the associated winning player as managed by the lottery gaming system 110 and the lottery gaming application 800 using the private DLT 108. In an embodiment, the cryptocurrency used for paying out the lottery prize may be one of: Bitcoin (BTC), Ethereum (ETH), Binance Coin (BNB), Tether (USDT), Solana (SOL), XRP (XRP), Cardano (ADA), USD Coin (USDC), Binance USD (BUSD), and Avalanche (AVAX).

However, if at step 410, no winner was determined in the initial round execution then, in accordance with the principles of the disclosed embodiments, multiple subsequent rounds (see, e.g., round 2 304, round 3 306 and round 4 308) may be executed in an embodiment until such time that a winner is determined. Thus, at step 412, establishing a revised set of winning numbers and redefining the number of matches required to win the lottery game (i.e., updating the plurality of winning lottery numbers and redefining the specified number of required winning number matches). In this way, in addition to updating the winner lottery numbers for each subsequent round and drawing, the specified number of required winning number matches is decreased for each subsequent round (e.g., from 6 to 5 to 4 to etc.) such that as multiple subsequent rounds are executed the number of winning lottery numbers required to match for a win decreases translating into increasing the odds of winning by any one player. Each subsequent round may be executed with all or any portion of the initial plurality of players that participated in the initial round executed. Further, for each such player that subsequently participated in later rounds (i.e., a player may drop out before the execution of any subsequent round) they will have the option of purchasing additional lottery tickets to add to their total number of tickets. Thus, at step 414, a determination is made as to whether any player has requested to purchase additional tickets for a subsequent round. If no such requests are made, then the operations return to step 408 for executing the subsequent rounds of the lottery until such time a winner is declared using each player's total current lottery ticket counts. If any additional ticket request is made, at step 416, receiving one or more subsequent lottery ticket requests, each of the one or more subsequent lottery ticket requests associated with a respective one player of a subsequent plurality of players and having a subsequent defined requested total lottery ticket count associated with the respective one player of the subsequent plurality of players, and wherein the subsequent plurality of players comprises all or any portion of the initial plurality of players and any new player joining for any subsequent round and the subsequent defined requested total lottery ticket count may be any number of lottery tickets. In this way, each player may continue to purchase lottery tickets for each subsequent round. As noted previously, there is no requirement for any player to continue playing the game in any subsequent round and they may exit the lottery game execution at any time. Further, there is no requirement to purchase any additional tickets for any subsequent rounds as their initially purchased lottery tickets are valid for every subsequent round until a winner is declared. Then, at step 418, issuing and recording on the DLT ledger a subsequent number of lottery tickets to each respective one player of the subsequent plurality of players in accordance with the subsequent defined requested total lottery ticket count associated therewith, each lottery ticket of the subsequent number of lottery tickets issued comprising a plurality of potential winning numbers. Further, at step 418, defining a current total number of lottery tickets issued for each respective one player of the subsequent plurality of players, the current total number of lottery tickets defined comprising a combination of the initial number of lottery tickets issued to the respective one player and any and all of the subsequent number of lottery tickets issue thereto. As such, if a player does subsequently request and purchase additional lottery tickets, they are combined to update their total issued lottery count (i.e., their initial lottery tickets and all subsequently purchased tickets) applicable to subsequent round(s). Then, the operations return to step 408 for executing the subsequent rounds of the lottery until such time a winner is declared using each player's current total issued lottery tickets for each as subsequent round until time that a winner is declared.

To further illustrate the aforementioned principles, the high-level lottery gaming methodology 300 shown in FIG. 3 illustrates an exemplary multi-round lottery game implemented and executed in accordance the principles of the disclosed embodiments. In particular, initial round 302 (i.e., round 1) will execute a lottery game comprising six (6) winning numbers with a lottery prize of $10,000 and having Player A with ten (10) lottery tickets requested and issued, as detailed above. Similarly, Player B has five (5) lottery tickets and Player C has three (3) tickets requested and issued, respectively. If no winner is declared after the execution of round 1 302, then subsequent round 2 304 will be executed. In this (and every other) subsequent round, each participating player may purchase any number of lottery tickets in any or all of the subsequent rounds. As such, in subsequent round 2 304, subsequent round 3 306, subsequent round 4 308 and all subsequent rounds executed as the lottery game continues until a winner is found at block 310, player A may be issued any number of newly purchased tickets in addition to their original ten (10) tickets, player B may be issued any number of newly purchased tickets in addition to their original five (5) tickets and player C may be issued any number of newly purchased tickets in addition to their original three (3) tickets. Of course, a player is under no requirement to purchase any additional tickets for the subsequent rounds and may use their initial number of lottery tickets issued for each such subsequent round. As shown, each subsequent round has an escalating lottery prize amount (i.e., $20,000 in round 2 304, $50,000 in round 3 306, and $70,000 in round 4 308) and decreasing number of winning numbers that are required to be matched (i.e., pick 5 numbers for round 2 304, pick 4 numbers for round 3 306, and pick 3 numbers for round 4 308). As such, this illustrative lottery game is in the well-known progressive lottery format where the lottery game prize increases each time the game is played but the lottery game prize is not won by any participating player. Illustratively, the increasing lottery game prizes shown in FIG. 3 are determined as a function of total lottery ticket purchases made for each round executed.

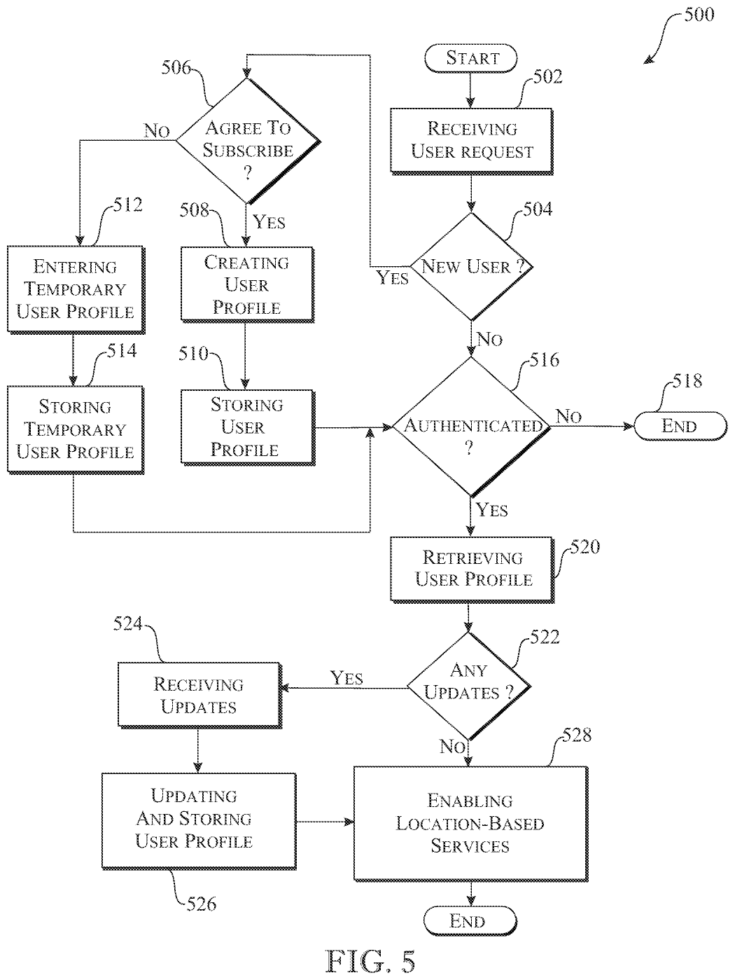

Turning our attention to FIG. 5, a flowchart of illustrative operations 500 is shown for user onboarding and subscription in accordance with an embodiment. The disclosed embodiments herein contemplate a subscription-based service for use by the users but may also be used in a non-subscribed platform. For example, subscribed users may have access to a larger variety of lottery games and/or lottery prizes. As such, at step 502, receiving a user request (e.g., the player 1 132). At step 504, determining if a user is a new or returning user (and also whether they are eligible for participating in lottery games, e.g., are they eighteen (18) years or older) and, if a new user, then at step 506 determining whether the user is agreeable to becoming a subscriber or not (e.g., in accordance with a user agreement and/or user privacy/security agreement). If so, then the new user is subscribed and, at step 508, a user profile is created and the user profile is stored, at step 510. Illustratively, the user profile may comprise, among other information, at least the user's name, a user ID, general account information (e.g., digital wallets and/or financial account passwords), and other associated information that may facilitate identifying players hereunder. If the user declines to become a subscriber, then they may proceed as a non-subscriber and will be entering, at step 512, a temporary user profile and storing the user profile at step 514. Illustratively, such a temporary user profile may be an abbreviated version of the aforementioned user profile. If the user is a returning user (or one of the newly subscribed users or new non-subscribed user), their identity is authenticated, at step 516 (e.g., using the aforementioned user ID). In an embodiment, two-factor authentication is used to verify the user's credentials (e.g., a text message to the user device 700 (e.g., the user device 1 126 so configured and employed by player 1 132) associated with this user or other third-party verification mechanisms) If not authenticated, then the operations end at step 518, and if they are authenticated then, at step 520, their respective stored user profile is retrieved. A determination is made, at step 522, as to whether any updates to the user profile are desired and if so, then at step 524, receiving the update, and updating and storing the user profile, at step 526. If no updates are necessary (or after the updating operations are completed), at step 528, then enabling location-based services to allow for identifying a real-time location of the user which may be useful information in deploying the various features of the disclosed embodiments that may utilize such current location status information. For example, the lottery game execution may be specific to a particular location and/or the lottery gaming application 800 may require location-based information during execution by the players.

Turning our attention to FIG. 6, a blockchain-based lottery gaming system 600 is configured in accordance with an embodiment. Illustratively, as noted previously, the lottery gaming system 110 is configured in accordance with the FIG. 6 architecture showing the blockchain-based lottery gaming system 600. As shown, the blockchain-based lottery gaming system 600 comprises processor 602 for executing program code (e.g., the lottery gaming app 800 configured in accordance with FIG. 8) and communications interface 614 for managing communications to and from the blockchain-based lottery gaming system 600, memory 606 and read-only memory (ROM) 608 for storing program code and data, and power source 618 for powering the blockchain-based lottery gaming system 600. The memory 606 is coupled to the bus 604 for storing computer-readable instructions (e.g., non-transitory computer readable medium) to be executed by the processor 602 including, but not limited to, the lottery gaming app 800. Database manager 612 is used to manage the delivery and storage of content, data, and other information in any well-known database(s) types (including but not limited to, the application data 112, and the private DLT data 114) and across third-party content providers, for example. As detailed herein, the operations performed by for the blockchain-based lottery gaming system 600 in combination with the lottery gaming app 800, for example, provide for the delivery of the lottery gaming services in accordance with the disclosed embodiments.

Web and mobile API manager 620 is used to deliver and manage content, data, and other information across one or more web-based applications (e.g., the web API 122 and the lottery gaming platform 146 enabled through the hybrid cloud environment 104) and mobile-based applications (e.g., the mobile API 120 and the lottery gaming application 800), as the case may, that may be utilized to access and use the blockchain-based lottery gaming system 600, for example. Further, the operations provided by and through the lottery gaming app 800 may be offered, in whole or in part, through a web-based application in addition to the mobile-based application. As will be discussed in greater detail herein below, the lottery gaming app 800, as stored in data storage 610, when executed by the processor 602 will enable access by a plurality of users (e.g., the player 1 132, player 2 134 through player N 136) to the blockchain-based lottery gaming system 600 for the lottery gaming application described herein. Such processing is further enabled by private DLT manager 624, public DLT manager 632, digital wallet manager 626, smart contract manager 628, cryptocurrency manager 630, and lottery winning number generator manager 634.

Location-based services manager 622 facilitates the delivery of location-based services (e.g., GPS tracking) either independently or on a user device (e.g., the user device 2 128) thereby allowing the blockchain-based lottery gaming system 600 to register the exact location of the user of the user device, for example, as the user roams from one location to another location such that the lottery game services offered may be tailored to and/or utilize a current location In an embodiment, the lottery gaming application provided through the execution of the lottery gaming app 800 may also include a web-based delivery platform and/or accessing and interfacing any number of websites using the web and mobile API manager 620 for procuring information and data that can be used in the blockchain-based lottery gaming system 600. The term “website” in the context herein is used in a conventional and broadest sense and is located on at least one server containing web pages stored thereon and is operational in a 24-hour/7-day typical fashion. The DLT-based lottery gaming system 600 may also include one or more input/output devices 616 that enable user interaction with the various user devices (e.g., camera, display, keyboard, mouse, speakers, microphone, buttons, etc.). The input/output devices may include peripherals, such as an NFC device (e.g., NFC tag reader), camera, printer, scanner (e.g., QR-code scanner), touchscreen display, etc. For example, the input/output devices 616 may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device or an associated display device, for example.

The communications interface 614 is used to facilitate communications across the communications links 140 (see, FIG. 1) within the cloud network services architecture 100. This may take the form, for example, of a wide area network connection that communicatively couples the blockchain-based lottery gaming system 600 with one or more access points which may include a cellular communications service. Similarly, communications managed by the communications interface 614 may take the form, for example, of a local Wi-Fi network interface or Ethernet interface the communicatively couples the blockchain-based lottery gaming system 600 with the well-known Internet, and ultimately to any user device. In the instant embodiment, the lottery gaming app 800 and/or the communications interface 614 may include a communications stack for facilitating communications over the respective communications link 140. Electronic communications by and through blockchain-based lottery gaming system 600 between the various systems, networks, devices, users, entities, and/or individuals are facilitated by the communications links 140 in accordance with any number of well-known communications protocols and methods (e.g., wireless communications).

Turning our attention to FIG. 7, an illustrative user device 700 is shown for use with the blockchain-based lottery gaming system 600, for example, in accordance with an embodiment. The user device 700 (e.g., the user device 1 126, the user device 2 128 and the user device N 130, as so configured) typically includes bus 702 and processor 704 coupled to the bus 702 for executing operations and processing information. As will be appreciated, a “user device” in the context herein may comprise a wide variety of devices such as any type of hardware device, user devices, smartphones, laptop computers, desktop computers, tablets, and wearable devices, to name just a few, that execute applications (e.g., a mobile application) in accordance with the principles of the disclosed embodiments herein. For example, the execution of the lottery gaming app 800 as detailed herein. The processor 704, as powered by power source 712, may include both general and special purpose microprocessors, and may be the sole processor or one of multiple processors of the device. This is equally applicable to the processor 602 of FIG. 6. Further, the processor 704 (or the processor 602) may comprise one or more central processing units (CPUs) and may include, be supplemented by, or incorporated in, one or more application-specific integrated circuits (ASICs) and/or one or more field programmable gate arrays (FPGAs).

The user device 700 may also include memory 706 coupled to the bus 702 for storing computer-readable instructions to be executed by the processor 704. The memory 706 may also be utilized for storing temporary variables or other intermediate information during the execution of the instructions by the processor 704. The user device 700 may also include ROM 708 or other static storage device coupled to the bus 702. Further, data storage device 710, such as a magnetic, optical, or solid-state device may be coupled to the bus 702 for storing information and instructions for the processor 704 including, but not limited to, the lottery gaming app 800. Data storage device 710 (or the data storage device 610) and the memory 706 (and the memory 606) may each comprise a non-transitory computer readable storage medium and may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

The user device 700 may also include one or more communications interface 716 for communicating with other devices via a network (e.g., a wireless communications network) or communications protocol (e.g., Bluetooth®). For example, such communication interfaces may be a receiver, transceiver, or modem for exchanging wired or wireless communications in any number of well-known fashions. For example, the communications interface 716 (or the communications interface 614) may be an integrated services digital network (ISDN) card or modem/router used to facilitate data communications of various well-known types and formats. Further, illustratively, the communications interface 716 (or the communications interface 614) may be a local area network (LAN) card used to provide data communication connectivity to a comparable LAN. Wireless communication links may also be implemented. The Global Positioning System (GPS) transceiver 718 and antenna 720 facilitate delivery of location-based services in order to register the exact location of the user device 700, for example, as the user roams from one location to another location. As will be understood, the application herein will be able to track individual users upon the launching of the application thereby enabling the well understood GPS location features of the user device 700 (e.g., a smartphone).

As will be appreciated, the functionality of the communication interface 716 (or the communications interface 614) is to send and receive a variety of signals (e.g., electrical, optical, or other signals) that transmit data streams representing various data types. The user device 700 may also include one or more input/output devices 714 that enable user interaction with the user device 700 such as a camera, display, keyboard, mouse, speakers, microphone, buttons, etc. The input/output devices 714 (or I/O devices 616) may include peripherals, such as an NFC device (e.g., NFC reader), camera, printer, scanner (e.g., QR-code scanner), touchscreen display, etc. For example, the input/output devices 714 (or the I/O devices 616) may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device 700 or an associated display device, for example.

Turning our attention to FIG. 8, an illustrative architecture for a lottery gaming app 800 for delivering and executing the aforementioned lottery gaming applications and associated operations and services in accordance with an embodiment. As will be appreciated, the architecture may be used, illustratively, in conjunction with the cloud network services architecture 100, the lottery gaming system 110, and/or the user device 700 for launching and executing the lottery gaming app 800. As shown, the architecture for the operations of the lottery gaming app 800 provides several interfaces and engines used to perform a variety of functions such as the collection, aggregation, manipulation, processing, analyzing, verification, authentication, and display of applicable real-time information and data that are useful to realize the delivery of the lottery gaming applications, as detailed herein. More particularly, data display interface module 818 and communications module 812 are used to facilitate the input/output and display of electronic data and other information to, illustratively, the users (e.g., the player 2 134) employing the user device 2 128 (e.g., a touch screen) for engaging with the lottery gaming app 800 and the execution thereof. The data collection module 806 facilitates data gathering from a plurality of users and other third parties. The location-based services module 820 provides for the delivery of location-based services in order for the geographic locations of the users to be identified and displayed (e.g., GPS locations) in accordance with any location and proximity-based features of the lottery gaming app 800. The communications module 812 will also facilitate communications by and through the lottery gaming system 110, for example.

Execution engine 802 may be employed to deliver the operations pursuant to the execution of the lottery gaming app 800. In such delivery, the execution engine 802 will operate and execute, as further detailed herein below, with at least the following program modules: private DLT administration and management module 804, data collection module 806, registration module 808, smart contract administration and management module 810, communications module 812, lottery gaming system operations module 814, digital wallet administration and management module 816, data display interface module 818, user administration and management module 822, cryptocurrency administration and management module 824, public DLT administration and administration module 826, lottery ticket and player administration and management module 828, and web and mobile API administration and management module 830, and lottery winning number generator module 832. The registration module 808 and the user administration management and administration module 822 provide, illustratively, for the delivery and management of a subscription-based services model whereby individual users subscribe in order to access the lottery gaming services hereunder by and through the execution of one or more of the lottery gaming app 800, for example. In an embodiment, the user may initially subscribe, as facilitated by the registration module 808 for a defined fee in a tier subscription system such that users who pay more for their access subscription are provided priority and other advantages (e.g., a wider selection of available lottery games and/or higher lottery prizes) over other users in lower tiers or who are subscribed through a base “no fee” trial plan (e.g., a free 30 day trial period). The registration module 808 will also provide for the creation and maintenance of individual user profiles for each user. Further, in an embodiment, the data display interface module 818, and the communications module 812 are used to facilitate the input/output and display of electronic data and other information (e.g., a graphical user interface) to, illustratively, the users employing the user device 700 (e.g., a touch screen of the user device 700) and executing any one of the lottery gaming app 800 including, but not limited to, the operations executed by each and every of the foregoing modules are, for example, as discussed throughout this disclosure.

Those skilled in the art will appreciate that the present disclosure contemplates the use of systems configurations and/or computer instructions that may perform any or all of the operations detailed herein above. For example, the disclosure of computer instructions that include, for example, the lottery gaming system 110 and the lottery gaming app 800 is not meant to be limiting in any way. Those skilled in the art will readily appreciate that stored computer instructions and/or systems configurations may be configured in any way while still accomplishing the various goals, features, and advantages according to the present disclosure. The terms “program,” “application,” “software application,” and the like as used herein, are defined as a sequence of instructions designed for execution on a computer system. A “program,” “computer program,” “application.” or “software application” may include a subroutine, a function, a procedure, an object method, an object implementation, an executable application, an applet, a servlet, a source code, an object code, a shared library/dynamic load library, and/or other sequence of instructions designed for execution on a computer system. Accordingly, the applications and programs, for example, may be written using any number of programming languages and/or executed on compatible platforms including, but not limited to, JavaScript, PHP (PHP: Hypertext Preprocessor), WordPress, Drupal, Laravel, React.js, Angular.js, and Vue.js. Computer readable program instructions for carrying out operations of the disclosed embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions (e.g., non-transitory computer readable mediums) may execute entirely on one or more standalone computers, partly on one or more standalone computers, as a stand-alone software package, partly on one or more standalone computers and partly on one or more remote computers, partly on one or more standalone computers and partly on one or more distributed computing environments (such as a cloud environment), partly on one or more remote computers and partly on one or more distributed computing environments, entirely on one or more remote computers or servers, or entirely on one or more distributed computing environments. Standalone computers, remote computers, and distributed computing environments may be connected to each other through any type of network or combination of networks, including local area networks (LANs), wide area networks (WANs), through the Internet (e.g., using an Internet Service Provider), or the connection may be made to external computers.

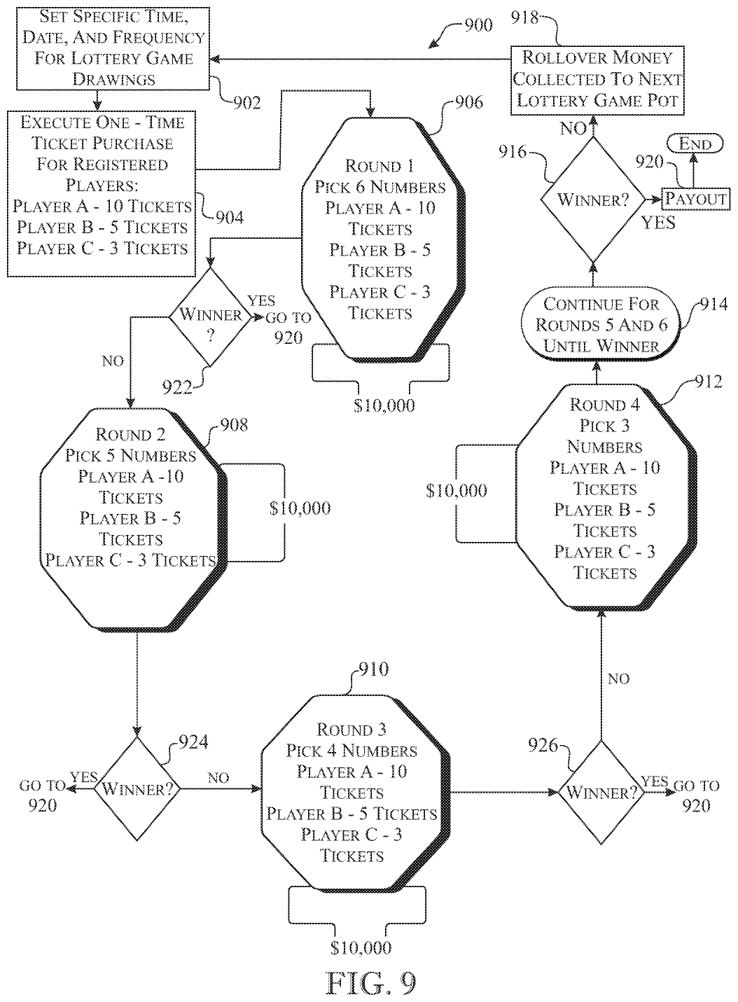

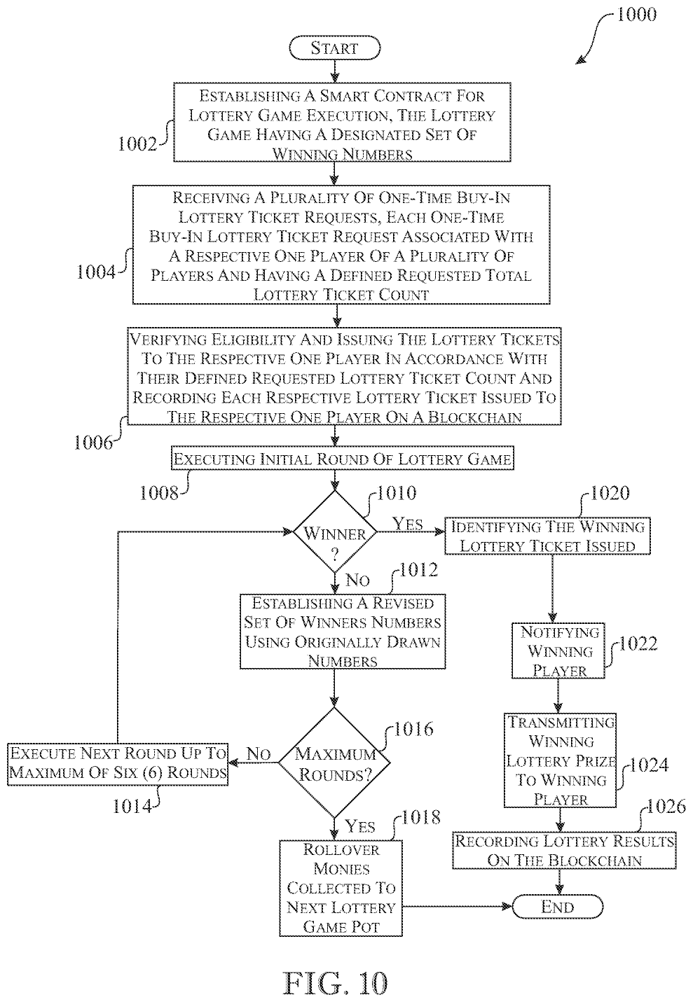

Turning our attention to FIGS. 9 and 10 which will now be discussed together, a flowchart showing a high-level lottery gaming methodology 900 is shown in FIG. 9 for implementing blockchain-based lottery games for a number of players and a one-time buy-in in accordance with an embodiment, and a flowchart of illustrative operations 1000 is shown in FIG. 10 for implementing and executing blockchain-based lottery games for a number of players and a one-time buy-in in accordance with an embodiment. More particularly, at step 1002, establishing a smart contract for lottery game execution wherein the lottery game comprises a designed set of winning numbers (e.g., a set of six (6) numbers that must be matched in order to win the lottery game) and there is a one-time lottery ticket buy-in per registered and participating player. Once the one-time lottery ticket buy-in is executed by a player they may not buy any additional tickets for that particular lottery game in any subsequent rounds, nor will any additional players be admitted to an ongoing lottery game once started. The smart contract may be recorded on the DLT ledger (e.g., the private DLT 108 and/or the public DLT 148) as well as part of this establishing step. Further, in an embodiment, the smart contract (e.g., the smart contract(s) 138) may be created by the lottery gaming system 110. Each lottery game may have an associated lottery game identification (ID) and lottery drawing schedule (e.g., a drawing date and one hour in between drawing rounds), a set of rules, and lottery ticket purchase cut-off time after which no further lottery tickets will be issued for the player one-time buy-in. In this way, the players may be presented (e.g., on a display of their user device) with a listing of available lottery games to choose from. At step 1004, receiving a plurality of one-time buy-in lottery ticket requests, each lottery ticket request associated with a respective one player of a plurality of players and having a defined requested total lottery ticket count associated with the respective one player (e.g., ten (10) tickets) In accordance with principles of the subject embodiment, a player may request, purchase and be issued any number of lottery tickets (i.e., there is no minimum or maximum) on a one-time basis. Each lottery ticket may have a designated purchased price (e.g., $10.00). In the embodiment, there is also a receiving payment for the number of lottery tickets issued to each respective one player of the initial plurality of players where the payment received may be in a fiat currency or a cryptocurrency Illustratively, payments may be made using a checking account or debit card. In the embodiment, there is a receiving a designation of the plurality of potential winning numbers for at least one lottery ticket of the number of lottery tickets issued from the respective one player of the initial plurality of players associated with the lottery ticket request therefore. Further, in the embodiment, there is receiving a designation of the plurality of potential winning numbers from a third-party service for at least one lottery ticket of the number of lottery tickets issued. In this way, the winning numbers for the lottery tickets issued may be chosen directly by the player and/or the third-party service. In accordance with the principles of the subject embodiment, each lottery ticket issued to any one player on the one-time buy-in basis will be valid for each of the lottery rounds executed (up to a designed maximum number; for example, six (6) rounds) for a particular game.

At step 1006, issuing and recording on the DLT the number of lottery tickets to each respective one player of the initial plurality of players in accordance with the defined requested total lottery ticket count associated therewith, each lottery ticket of the number of lottery tickets issued comprising a plurality of potential winning numbers. As part of step 1006, there may also be a verification that the lottery ticket request is from an eligible player (e.g., must be eighteen (18) years or older) Once issued the lottery tickets issued to any one player are secured by lottery gaming system 110 such that only that player may view and access their respective issued lottery tickets. This increases overall lottery game security and confidence that the lottery games are executed in a fair and transparent fashion. Then, at step 1008, executing the lottery game in a round-by-round fashion under the direction of the smart contract. That is, a multi-round lottery game is executed in accordance with a preferred embodiment and the lottery game's execution begins with an initial round. As noted above, the winning numbers for each game are generated and provided by the lottery winning number generator 116 (either independently by the lottery gaming system 110 and/or the lottery number generator 116 itself, or as provided by a third-party service). To be clear, once the set of six (6) numbers are issued these same numbers will be used for each round executed to determine a matching winner (e.g., 6/6, 5/6, 4/6, 3/6, etc.). New numbers are only issued at the start of each new game (i.e., not each round of a specific game). At step 1010, determining whether any one of the respective one players of the plurality of players is a winner of the first round of the lottery game (see, e.g., round 1 906 in FIG. 9) executed based on a matching of a specified number of required winning number matches between the plurality of potential winning numbers of a particular one lottery ticket of the number of lottery tickets issued thereto with the plurality of winning numbers of the lottery game. Illustratively, in the execution of this initial round the specified number of required winning numbers is equal to the plurality of winning numbers associated with the lottery game at the outset (e.g., six (6) numbers). If a winner is determined based on the matching, then at step 1020, identifying the particular one lottery ticket of the initial number of lottery tickets issued to the respective one player determined as the winner of the lottery game based on the matching, and notifying, at step 1022, the winner of their lottery game win. Such notification may come in a variety of forms (e.g., telephone call, electronic mail, text message, etc.) At step 1024, transmitting a lottery prize (e.g., $10,000) associated with the lottery game to the winner and recording, at step 1026, the lottery results on the DLT ledger (e.g., a blockchain). Then, closing out the DLT ledger and the operations end. In an embodiment, there may be a receiving from the winner of the lottery game a currency type for use in the transmitting a lottery prize associated with the lottery game, and the currency type may be a fiat currency or a cryptocurrency. That is, the player may designate the currency in which they wish to receive their lottery winnings (such designation may be made either before or after execution of the lottery game). In an embodiment, the DLT-based lottery gaming system using the private DLT, provides a plurality of private digital wallets (e.g., the private controlled digital wallets 124), wherein each private digital wallet of the plurality of private wallets being specific to a respective one player of the plurality of players. In this way, the lottery prize may be distributed to the private wallet of the winning party. Thus, in an embodiment, the lottery prize is distributed by a DLT-based lottery gaming system (e.g., the lottery gaming system 110) using a private digital wallet (e.g., the private controlled digital wallets 124) specific to the associated winning player as managed by the lottery gaming system 110 and the lottery gaming application 800 using the private DLT 108. Thus, at step 1026, issuing and recording on the DLT ledger recording the winning lottery results on the blockchain.

However, if at step 1010, no winner was determined in the initial round execution then, in accordance with the principles of the disclosed embodiments, multiple subsequent rounds (see, e.g., round 2 908, round 3 910 and round 4 912) may be executed until such time that a winner is determined by continuing for the maximum number of rounds at steps 1014 and 1016 (e.g., six (6) rounds total). Thus, at step 1012, establishing a revised set of winning numbers and redefining the number of matches required to win the lottery game (i.e., updating the plurality of winning lottery numbers and redefining the specified number of required winning number matches). As noted above, the revised set of winning numbers is a new subset of the originally issued winning numbers (e.g., 5/6, 4/6, etc.). In this way, in addition to updating the winner lottery numbers for each subsequent round and drawing, the specified number of required winning number matches is decreased for each subsequent round (e.g., from 6 to 5 to 4 to etc.) such that as multiple subsequent rounds are executed the number of winning lottery numbers required to match for a win decreases translating into increasing the odds of winning by any one player. Further, at step 1018, in the event no winner is declared after the maximum number of rounds have been played, the monies collected are rolled over to the next lottery game pot. Further, at step 1026, issuing and recording on the DLT ledger recording the non-winner lottery results on the blockchain.

To further illustrate the aforementioned principles, FIG. 9 shows a flowchart showing a high-level lottery gaming methodology 900 for implementing blockchain-based lottery games for a number of players and a one-time buy-in accordance with an embodiment as detailed above. In particular, the lottery game is set for a specific time and drawing frequency at block 902 and will be executed and administered by a smart contract (e.g., the smart contract 138 and smart contract 208). The interested players make, at block 904, their one-time buy-in of the number of lottery tickets they wish to purchase. Then, initial round 906 (i.e., round 1) will be executed of the lottery game comprising six (6) winning numbers with a lottery prize of $10,000 and having Player A with ten (10) lottery tickets requested and issued, as detailed above, on a one-time buy-in basis. Similarly, Player B has five (5) lottery tickets and Player C has three (3) tickets requested and issued, respectively. At step 922, if no winner is declared after the execution of round 1 906, then subsequent round 2 908 will be executed. In this (and every other) subsequent round, each participating player participates in any or all of the subsequent rounds in accordance with their one-time ticket buy-in (i.e., no additional tickets may be purchased at any time). As such, in subsequent round 2 908 and step 924, subsequent round 3 910 and step 926, subsequent round 4 912 and all subsequent rounds 914 executed as the lottery game continues until a winner is found at block 916. If there is no winner, the collected monies are rolled over at block 918 to the next lottery game pot. If a winner is declared, then the lottery money payout is made at block 920. As shown, each subsequent round has a fixed lottery prize amount (i.e., $10,000 in round 2 304, $10,000 in round 3 306, and $10,000 in round 4 308) and decreasing number of winning numbers that are required to be matched (i.e., pick 5 numbers for round 2 304, pick 4 numbers for round 3 306, and pick 3 numbers for round 4 308). Thus, this illustrative lottery game is in the well-known progressive lottery format where the lottery game prize increases each time the game is played but the lottery game prize is not won by any participating player. Illustratively, the increasing lottery game prizes shown in FIG. 9 are determined as a function of total lottery ticket purchases made for each round executed. As is well-known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Thus, in accordance with the principles of the disclosed embodiments, a lottery game, method, application and/or system is provided that involves lottery numbers which decrease and a jackpot that increases and in which allows players winning percentages to increase as the rounds progress. In summary, what takes place when an individual plays the lottery game in accordance with the principles of the disclosed embodiments and purchases tickets in a round one (1):
You are playing with six (6) numbers, and able to purchase other tickets in each round, from round one (1) to round six (6).
In round two (2), you are using those six (6) numbers to come up with (i.e., match) five (5) winning numbers that have been drawn (e.g., using a random number generator).
   If you are a late arrival to play the game and purchase tickets in this round you will only have five (5) numbers to match the five (5) winnings numbers. Those five (5) numbers will be good and valid for all other subsequent rounds.
In round three (3), you are using those same six (6) numbers to match with four (4) numbers that have been drawn.
   If you are a late arrival to play the game and purchase tickets in this round you will only have four (4) numbers to match the four (4) winning numbers. Those four (4) numbers will be good and valid for all other subsequent rounds.
In round four (4), you are using those same six (6) numbers to match with the three (3) numbers that have been drawn, and if there is no winner then the game proceeds to subsequent rounds.
   If you are a late arrival to play the game and purchase tickets in this round you will only have three (3) numbers to match the three (3) winning numbers. Those three (3) numbers will be good for all other subsequent rounds if there is no winner then the game proceeds to subsequent rounds.

Those of skill in the art will appreciate that where appropriate, some embodiments of the disclosure may be practiced in network computing environments with many types of computer system configurations, including personal computers, handheld devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. “Software” may refer to prescribed rules to operate a computer. Examples of software may include code segments in one or more computer-readable languages; graphical and or/textual instructions; applets; pre-compiled code; interpreted code; compiled code; and computer programs. A network is a collection of links and nodes (e.g., multiple computers and/or other devices connected together) arranged so that information may be passed from one part of the network to another over multiple links and through various nodes. Examples of networks include the Internet, the public switched telephone network, wireless communications networks, computer networks (e.g., an intranet, an extranet, a local-area network, or a wide-area network), wired networks, and wireless networks.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the func-tions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block dia-grams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium pro-duce an article of manufacture including instructions which implement the function/act specified in the flowchart and/or block diagram block or blocks. Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media. When a single device or article is described herein, it will be readily apparent that more than one device/article (whether or not they cooperate) may be used in place of single device/article. Similarly, where more than one device or article is described herein (whether or not they cooperate), it will be readily apparent that a single device/article may be used in place of the more than one device or article. The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory Volatile media include dynamic random access memory (DRAM), which typically constitutes the main memory. Transmission media include coaxial cables, copper wire and fiber optics, including the wires that com-prise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read. Various forms of computer readable media may be involved in carrying sequences of instructions to a processor. For example, sequences of instruction may be delivered from RAM to a processor, may be carried over a wireless transmission medium, and/or may be formatted according to numerous formats, standards or protocols, such as Bluetooth, 4G, 5G, etc.

As noted above, in some embodiments the method(s) described above may be executed or carried out by a computing system including a non-transitory computer-readable storage medium, also described herein as a storage machine, that holds machine-readable instructions executable by a logic machine (i.e., a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

As noted above, in some embodiments the method or methods described above may be executed or carried out by a computing system including a non-transitory computer-readable storage medium, also described herein as a storage machine, that holds machine-readable instructions executable by a logic machine (i.e., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Thus, the steps of the disclosed method(s) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine, or processor, whether or not such computer, machine or processor is explicitly shown. One skilled in the art will recognize that an implementation of an actual computer or computer system may have other structures and may contain other components as well, and that a high-level representation of some of the components of such a computer is for illustrative purposes.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A lottery system comprising:
a processor;
a memory storing instructions that when executed cause the processor to perform operations comprising:
executing a smart contract associated with a lottery game, the lottery game comprising a plurality of winning numbers;
under control of the smart contract executed:
receiving an initial plurality of lottery ticket requests, each initial lottery ticket request associated with a respective one player of an initial plurality of players and having an initial defined requested total lottery ticket count associated with the respective one player;
issuing and recording on a distributed technology ledger (DLT) an initial number of lottery tickets to each respective one player of the initial plurality of players in accordance with the initial defined requested total lottery ticket count associated therewith, each lottery ticket of the initial number of lottery tickets issued comprising a plurality of potential winning numbers;
executing an initial round of the lottery game;
determining whether any one of the respective one players of the initial plurality of players is a winner of the initial round of the lottery game executed based on a matching of a specified number of required winning number matches between the plurality of potential winning numbers of a particular one lottery ticket of the initial number of lottery tickets issued thereto with the plurality of winning numbers of the lottery game, and in accordance with the determination:
if the winner of the lottery game is determined then:
identifying the particular one lottery ticket of the initial number of lottery tickets issued to the respective one player determined as the winner of the lottery game based on the matching;
notifying the respective one player determined as the winner of the lottery game of their lottery game win;
transmitting a lottery prize associated with the lottery game to the respective one player determined as the winner; and
recording results of the lottery game executed on the DLT ledger;
otherwise, if the winner of the lottery game is not determined then:
(a) updating the plurality of winning lottery numbers and redefining the specified number of required winning number matches;
(b) receiving one or more subsequent lottery ticket requests, each of the one or more subsequent lottery ticket requests associated with a respective one player of a subsequent plurality of players and having a subsequent defined requested total lottery ticket count associated with the respective one player of the subsequent plurality of players, and wherein the subsequent plurality of players comprises all or any portion of the initial plurality of players and any new player joining for any subsequent round and the subsequent defined requested total lottery ticket count may be any number of lottery tickets;
(c) issuing and recording on the DLT ledger a subsequent number of lottery tickets to each respective one player of the subsequent plurality of players making the one or more subsequent lottery ticket requests in accordance with the subsequent defined requested total lottery ticket count associated therewith, each lottery ticket of the subsequent number of lottery tickets issued comprising a plurality of potential winning numbers;
(d) defining a current total number of lottery tickets issued for each respective one player of the subsequent plurality of players, the current total number of lottery tickets defined comprising a combination of the initial number of lottery tickets issued to the respective one player and any and all of the subsequent number of lottery tickets issue thereto;
(e) executing a subsequent round of the lottery game;
(f) determining whether any one of the respective one players of the subsequent plurality of players is a winner of the subsequent round of the lottery game executed based on a matching of the specified number of required winning number matches redefined between the plurality of potential winning numbers of a particular one lottery ticket of the current total number of lottery tickets defined with the plurality of winning numbers updated, and in accordance with the determination:
(g) if the winner is identified then:
identifying the particular one lottery ticket of the current total number of lottery tickets issued to the respective one player of the subsequent plurality of players determined as the winner of the lottery game;
notifying the respective one player of the subsequent plurality of players determined as the winner of the lottery game of their lottery win;
transmitting the lottery prize associated with the lottery game to the respective one player of the subsequent plurality of players determined as the winner; and
recording results of the lottery game executed on the DLT ledger;
otherwise, if the winner of the subsequent round of the lottery game executed is not determined then repeating steps (a) through (g) until the winner is determined.

2. The lottery system of claim 1, wherein the DLT ledger is a private blockchain.

3. The lottery system of claim 1, wherein the DLT ledger is a public blockchain.

4. The lottery system of claim 1, wherein the lottery prize transmitted in either a cryptocurrency or a fiat currency.

5. The lottery system of claim 4, wherein the cryptocurrency is one of: Bitcoin (BTC), Ethereum (ETH), Binance Coin (BNB), Tether (USDT), Solana (SOL), XRP (XRP), Cardano (ADA), USD Coin (USDC), Binance USD (BUSD), and Avalanche (AVAX).

6. The lottery system of claim 1, wherein the lottery prize transmitted is to a digital wallet associated with the winner of the lottery game.

7. The lottery system of claim 1, wherein the redefining the specified number of required winning number matches is a function of a decrease in the specified number of required winning number matches.

8. The lottery system of claim 1, wherein the operations performed by the processor further comprise:
receiving a designation of the plurality of winning numbers and the plurality of winning numbers updated from a third-party service.

9. The lottery system of claim 8, wherein the third-party service employs a random number generator for the designation of the plurality of winning numbers and the plurality of the winning numbers updated.

10. The lottery system of claim 9, wherein the random number generator is a blockchain-based verifiable random number generator.

11. The lottery system of claim 1, wherein the operations performed by the processor further comprise:
receiving from the winner of the lottery game a currency type for use in the transmitting a lottery prize associated with the lottery game.

12. The lottery system of claim 1, wherein the operations performed by the processor further comprise:
receiving a designation of the plurality of potential winning numbers from a third-party service for at least one lottery ticket of the initial number of lottery tickets issued and the subsequent number of lottery tickets issued.

13. The lottery system of claim 12, wherein the operations performed by the processor further comprise:
receiving a designation of the plurality of potential winning numbers for at least one lottery ticket of the initial number of lottery tickets issued from the respective one player of the initial plurality of players associated with the initial lottery ticket request therefore.

14. The lottery system of claim 1, wherein the plurality of winning numbers are defined by a respective round being played.

15. The lottery system of claim 1, wherein the operations performed by the processor further comprise:
recording the smart contract on the DLT ledger; and
receiving payment for the initial number of lottery tickets issued to each respective one player of the initial plurality of players and the subsequent number of lottery tickets issued to each respective one player of the subsequent plurality of players.

16. A lottery system comprising:
a display;
a processor;
a memory storing instructions that when executed cause the processor to perform operations comprising:
executing a smart contract associated with a lottery game, the lottery game comprising a plurality of winning numbers, wherein the plurality of winning numbers comprise a total of at least three (3) winning numbers;
under control of the smart contract executed:
receiving an initial plurality of lottery ticket requests, each initial lottery ticket request associated with a respective one player of an initial plurality of players and having an initial defined requested total lottery ticket count associated with the respective one player;
issuing and recording on a distributed technology ledger (DLT) an initial number of lottery tickets to each respective one player of the initial plurality of players in accordance with the initial defined requested total lottery ticket count associated therewith, each lottery ticket of the initial number of lottery tickets issued comprising a plurality of potential winning numbers;
executing an initial round of the lottery game;
determining whether any one of the respective one players of the initial plurality of players is a winner of the initial round of the lottery game executed based on a matching of a specified number of required winning number matches between the plurality of potential winning numbers of a particular one lottery ticket of the initial number of lottery tickets issued thereto with the plurality of winning numbers of the lottery game, and in accordance with the determination:
if the winner of the lottery game is determined then:
identifying the particular one lottery ticket of the initial number of lottery tickets issued to the respective one player determined as the winner of the lottery game based on the matching;
notifying the respective one player determined as the winner of the lottery game of their lottery game win;
transmitting a lottery prize associated with the lottery game to the respective one player determined as the winner, wherein the lottery prize transmitted is in either a cryptocurrency or a fiat currency; and
recording results of the lottery game executed on the DLT ledger;
otherwise, if the winner of the lotter game is not determined then:
(a) updating the plurality of winning lottery numbers and redefining the specified number of required winning number matches;
(b) receiving one or more subsequent lottery ticket requests, each of the one or more subsequent lottery ticket requests associated with a respective one player of a subsequent plurality of players and having a subsequent defined requested total lottery ticket count associated with the respective one player of the subsequent plurality of players, and wherein the subsequent plurality of players comprises all or any portion of the initial plurality of players and any new player joining for any subsequent round and the subsequent defined requested total lottery ticket count may be any number of lottery tickets;
(c) issuing and recording on the DLT ledger a subsequent number of lottery tickets to each respective one player of the subsequent plurality of players making the one or more subsequent lottery ticket requests in accordance with the subsequent defined requested total lottery ticket count associated therewith, each lottery ticket of the subsequent number of lottery tickets issued comprising a plurality of potential winning numbers;
(d) defining a current total number of lottery tickets issued for each respective one player of the subsequent plurality of players, the current total number of lottery tickets defined comprising a combination of the initial number of lottery tickets issued to the respective one player and any and all of the subsequent number of lottery tickets issue thereto;
(e) executing a subsequent round of the lottery game;
(f) determining whether any one of the respective one players of the subsequent plurality of players is a winner of the subsequent round of the lottery game executed based on a matching of the specified number of required winning number matches redefined between the plurality of potential winning numbers of a particular one lottery ticket of the current total number of lottery tickets defined with the plurality of winning numbers updated, and in accordance with the determination:
(g) if the winner is identified then:
identifying the particular one lottery ticket of the current total number of lottery tickets issued to the respective one player of the subsequent plurality of players determined as the winner of the lottery game;
notifying the respective one player of the subsequent plurality of players determined as the winner of the lottery game of their lottery win;
transmitting the lottery prize associated with the lottery game to the respective one player of the subsequent plurality of players determined as the winner, wherein the lottery prize transmitted is in either a cryptocurrency or a fiat currency; and
recording results of the lottery game executed on the DLT ledger;
otherwise, if the winner of the subsequent round of the lottery game executed is not determined then repeating steps (a) through (g) until the winner is determined.

17. The lottery system of claim 16, wherein the operations performed by the processor further comprise:
receiving a designation of the plurality of winning numbers from a third-party service, wherein the third-party service employs a random number generator for generating the plurality of winning numbers.

18. The lottery system of claim 16, wherein the DLT ledger is a private blockchain.

19. The lottery system of claim 16, wherein the operations performed by the processor further comprise:
recording the smart contract on the DLT ledger; and
receiving payment for the initial number of lottery tickets issued to each respective one player of the initial plurality of players and the subsequent number of lottery tickets issued to each respective one player of the subsequent plurality of players.

20. A lottery system comprising:
a display;
a processor;
a memory storing instructions that when executed cause the processor to perform operations comprising:
recording a smart contract associated with a lottery game on a distributed technology ledger (DLT) ledger, wherein the DLT ledger is a blockchain;
receiving a designation of a plurality of winning numbers for the lottery game from a third-party service, wherein the third-party service employs a random number generator for the designation of the plurality of winning numbers;
executing the smart contract associated with the lottery game;
under control of the smart contract executed:
receiving an initial plurality of lottery ticket requests, each initial lottery ticket request associated with a respective one player of an initial plurality of players and having an initial defined requested total lottery ticket count associated with the respective one player;
issuing and recording on the DLT an initial number of lottery tickets to each respective one player of the initial plurality of players in accordance with the initial defined requested total lottery ticket count associated therewith, each lottery ticket of the initial number of lottery tickets issued comprising a plurality of potential winning numbers, wherein the plurality of potential winning numbers for at least one lottery ticket of the initial number of lottery tickets issued are designated by the respective one player of the initial plurality of players associated with the initial lottery ticket request therefore;
executing an initial round of the lottery game;
determining whether any one of the respective one players of the initial plurality of players is a winner of the initial round of the lottery game executed based on a matching of a specified number of required winning number matches between the plurality of potential winning numbers of a particular one lottery ticket of the initial number of lottery tickets issued thereto with the plurality of winning numbers of the lottery game, and in accordance with the determination:
if the winner of the lottery game is determined then:
identifying the particular one lottery ticket of the initial number of lottery tickets issued to the respective one player determined as the winner of the lottery game based on the matching;
notifying the respective one player determined as the winner of the lottery game of their lottery game win;
receiving from the respective one player determined as the winner of the lottery game a currency type for use in transmitting a lottery prize associated with the lottery game;
transmitting, in the currency type received, the lottery prize associated with the lottery game to the respective one player determined as the winner, wherein the currency type is either a cryptocurrency or a fiat currency; and
recording results of the lottery game executed on the DLT ledger;
otherwise, if the winner of the lotter game is not determined then:
(a) updating the plurality of winning lottery numbers and redefining the specified number of required winning number matches;
(b) receiving one or more subsequent lottery ticket requests, each of the one or more subsequent lottery ticket requests associated with a respective one player of a subsequent plurality of players and having a subsequent defined requested total lottery ticket count associated with the respective one player of the subsequent plurality of players, and wherein the subsequent plurality of players comprises all or any portion of the initial plurality of players and any new player joining for any subsequent round and the subsequent defined requested total lottery ticket count may be any number of lottery tickets;
(c) issuing and recording on the DLT ledger a subsequent number of lottery tickets to each respective one player of the subsequent plurality of players making the one or more subsequent lottery ticket requests in accordance with the subsequent defined requested total lottery ticket count associated therewith, each lottery ticket of the subsequent number of lottery tickets issued comprising a plurality of potential winning numbers, wherein the plurality of potential winning numbers for at least one lottery ticket of the subsequent number of lottery tickets issued are designated by the third-party service;
(d) defining a current total number of lottery tickets issued for each respective one player of the subsequent plurality of players, the current total number of lottery tickets defined comprising a combination of the initial number of lottery tickets issued to the respective one player and any and all of the subsequent number of lottery tickets issue thereto;
(e) executing a subsequent round of the lottery game;
(f) determining whether any one of the respective one players of the subsequent plurality of players is a winner of the subsequent round of the lottery game executed based on a matching of the specified number of required winning number matches redefined between the plurality of potential winning numbers of a particular one lottery ticket of the current total number of lottery tickets defined with the plurality of winning numbers updated, and in accordance with the determination:
(g) if the winner is identified then:
identifying the particular one lottery ticket of the current total number of lottery tickets issued to the respective one player of the subsequent plurality of players determined as the winner of the lottery game;
notifying the respective one player of the subsequent plurality of players determined as the winner of the lottery game of their lottery win;
transmitting the lottery prize associated with the lottery game to the respective one player of the subsequent plurality of players determined as the winner, wherein the lottery prize transmitted is in either a cryptocurrency or a fiat currency; and
recording results of the lottery game executed on the DLT ledger,
otherwise, if the winner of the subsequent round of the lottery game executed is not determined then repeating steps (a) through (g) until the winner is determined.
